(19) United States
(12) Patent Application Publication
(10) Pub. No.: US 2002/0157041 A1
(43) Pub. Date: Oct. 24, 2002

(54) Protocol parser-code generator

(76) Inventors: David Charles Bennett, Apex, NC (US); Richard P. Haney, Chapel Hill, NC (US); Bina Kunal Thakkar, Cary, NC (US)

Correspondence Address: MOORE & VAN ALLEN, PLLC, 2200 W MAIN STREET, SUITE 800, DURHAM, NC, 27705, US

(21) Appl. No.: 09/840,253

(22) Filed: Apr. 23, 2001

(51) Int. Cl. H04B 1/74

(52) U.S. Cl. 714/43

(57) ABSTRACT

Protocol Parser—Code Generator. A protocol parser—code generator provides use of a protocol definition language for allowing protocol information to be decoupled from operating systems and computer languages. For producing protocol knowledge of the structure of a protocol data unit for use in the analysis of network frame traffic, the invention works by allowing the use of a protocol definition language to define the data structure of fields in a protocol data unit in keywords. A parser associates each of the keywords describing the data structure of the fields with a corresponding table of a set of tables. Each table is linked together and has a data structure fields. A code generator then generates field code for each of the tables for use in providing protocol knowledge of the data structure of each of the fields of the protocol data unit.

### CROSS REFERENCE TO RELATED APPLICATIONS

Some of the material disclosed and claimed in this application is also disclosed in one or more of the following commonly owned, copending U.S. patent applications: Ser. No. (Docket No. 230600-428) entitled: Protocol Emulator, filed on even date herewith by Bina Kunal Thakkar, Ser. No. (Docket No. 230600-430) entitled: Protocol Encoder and Decoder, filed on even date herewith by Bina Kunal Thakkar, and Ser. No. (Docket No. 013777-02) entitled: Protocol Monitor, filed on even date herewith by William George Krieski and Bina Kunal Thakkar, which are incorporated herein by reference.

### BACKGROUND

1. Field of the Invention

This invention relates to the field of data communications networks, and more particularly to network devices for monitoring and analyzing such networks.

2. Description of the Problem

Networks represent shared access arrangements in which several network devices, such as computers or workstations, are interconnected by a common communications medium to allow users to share computing resources, such as file servers and printers, as well as application software and user work product. The communication medium may be wireline, such as by coaxial, twisted pair, or fiber optic cable, or wireless, such as cellular or radio frequency transmission. The most common types of networks are local area networks (LANs) and wide area networks (WANs). The network devices in a LAN are interconnected within a “local” area, such as in a home or office. In a WAN, the network devices are further apart and interconnected via transmission lines (also called circuits, channels, or trunks) and switching elements (variously called packet switching nodes, intermediate systems, and data switching exchanges).

In order to reduce the design complexity in transmitting data from one network device to another, most networks have been organized as a series of layers in a “protocol hierarchy.” Each layer represents a function performed when data is transferred between cooperating applications on communicating network devices. Each of the layers define a function of data communications protocols between the network devices on a network. A layer does not define a single protocol, it defines a data communications function that may be performed by any number of protocols. Therefore, each layer may contain multiple protocols, each providing a service suitable to the function of that layer.

A set of layers and protocols define the network architecture. Two common network architectures are the Open Systems Interconnection (OSI) reference model and the Transmission Control Protocol/Internet Protocol (TCP/IP) reference model. For illustrative purposes, the OSI reference model 200 is shown in FIG. 2, which provides an example of data transmission over a network. The TCP/IP reference model and other network architectures are similar to the OSI reference model 200 in defining data transmission over a network. Referring to FIG. 2, a network device 201 has data 214 for transmission to another network device 202. Data 214 can be any type of communication that is to be transmitted between two network devices, such as a control protocol which establishes communication links between network devices.

When a network device 201 transmits data 214 to the network, each layer 203, 205, 206, 207, 210, 211, 212 processes the data 214 in turn. The data 214 is first given to the application layer 203, which attaches an application header (AH) 216 to the front of the data 214 and, depending on the protocol, a trailer to the end of the data 214. The data 214 and attached application header 216, and possibly trailer, together are generally known as a protocol data unit (PDU) 220. The header is always included in a PDU. The content of the header and trailer vary depending on the particular protocol of the PDU. Some protocols do not make use of trailers. The header and trailer provide information such as addressing and transmission error checking. The header and trailer of a PDU are sectioned into fields, which contain bit data depending on how the particular protocol defines the field. The PDU describes the combination of the control information for a layer, any attached header or trailer, with the PDU provided by the next higher layer. The PDU provided from the next higher layer is known as payload, for example the payload 218 of the application layer 203.

The application layer 203 functions to provide application programs on a network device with communication through the network. The data 214 from the application program is attached to the application header 216 by the application layer 203. This application PDU 204 is then passed to the presentation layer 205. Each of the subsequent layers appends another header and possibly trailer to the PDU from the next higher layer. This process is repeated until the data 214 finally reaches the physical layer 206, where the data 214, attached headers, and attached trailers are transmitted to the network communication medium 209 in the form of a network frame. A network frame is the “package” of bits physically transmitted over the network communication medium 209. The network frame is comprised of data 214 from the application program and any attached headers or trailers from the various layers 203, 205, 206,207, 210, 211, 212.

The receive data network device 202 is the network device at which the data 214 is to be received. At the receive data network device 202, the attached headers from the various layers 203, 205, 206, 207, 210, 211, 212 are removed one by one as the transmitted data 214 propagates up the layers 208. Although each layer is programmed as though it were horizontal, the actual data transmission is vertical. Each layer is effectively “communicating” directly with another layer in the protocol hierarchy without regard to the other layers.

Each layer 203, 205, 206, 207, 210, 211, 212 in the hierarchy has a different function. The physical layer 206 defines the characteristics of the hardware necessary to carry the network frame over the network communication medium 209. The data link layer 210 packages data bits into a network frame and then transmits the network frame from one network device to another. If the receiving network device 202 does not send an acknowledgment of receipt, the data link layer 210 will resend the frame. These are some of the responsibilities of a control protocol when setting up a link between network devices. The network layer 211 addresses messages, determines the route that the network frame takes through the network, and manages traffic problems. The transport layer 212 is responsible for error recognition and recovery, repackaging of long messages into smaller packages, and providing an acknowledgment of network frame receipt. The session layer 207 allows two cooperating applications on different network devices to communicate by establishing a communication control between the two network devices 201, 202 that regulates which side transmits, when each side transmits, and for how long. The presentation layer 205 translates data 214 from the application layer 203 into an intermediate format and provides data encryption and compression services.

Protocols operate as distinct programs or processes that the network uses to transmit data between network devices. A set of network protocol layers that work together is known as a protocol stack. The attached headers and trailers each contain different protocol data. In this way, protocol data is embedded within one another making up the protocol stack.

Network frame decoding and encoding is a basic and fundamental functionality of network devices. For example, network traffic may be emulated by a network device such as a network analyzer in order to discover network problems. In order to do so, network frames intercepted from the network must be decoded for analysis by a network device user and encoded. An example of a network device that can be used to monitor network traffic is a network analyzer. Generally, protocols are emulated by use of finite state machines. The network device will receive network frames from the network, decode those frames, take action based on the current state of the finite state machine, encode a network frame for response, and then transmit the network frame to the network. Additionally, a network device user may construct a network frame for transmission in order to analyze the network's response.

There are hundreds of protocols and, therefore, hundreds of different types of network frames that may be handled by a network device. Network protocols are complex and many protocols co-exist on the network. This makes it difficult to develop network devices and equipment. Currently, software code for decoding, encoding and emulation is tightly coupled to protocol. For the designer of network devices, this requires a significant effort in software and hardware development, testing, and maintenance of each new protocol. There is a significant drain of resources in programming because each protocol possible on a network must be decoded for presentation to a user. Additionally, because protocol information is coupled to operating systems and computer languages, gathered protocol information cannot be reused on different operating systems and with different computer languages. Development would proceed much more efficiently if it were decoupled. This is because it is often that different projects in a company use different computer language. Also, equipment is typically composed of various subsystems, and each subsystem may use different computer languages.

### SUMMARY

This invention provides a solution that allows a user to decouple protocol information from operating systems and computer languages by eliminating a need to write protocol specific software. This invention provides a protocol definition language that can be reused on different operating systems and computer languages. Because the invention decouples software code generation from specific protocols, developers are able to more quickly generate code or hardware designs for network devices that use different operating systems or languages. In one embodiment, the user defines the data structure of a protocol in a protocol definition language. The data structure of the protocol is in terms of the fields of the protocol data unit of the protocol. The data structure provides information such as the offset of the beginning of a field and the length of the field. A parser associates the set of keywords describing the data structure of the field in a protocol data unit that is being defined with a corresponding table of a set of tables. Each of the tables has a set of data structures defining a field. These tables are then linked in a memory device to order the tables of the protocol data unit with one another. A code generator then generates field code that is specific to a particular software or operating system for each of the field tables. The code that results is for use in providing protocol knowledge of the data structure of each of the fields of the protocol data unit for use in the analysis of network traffic.

The software which implements many aspects of the invention can be stored on a media. The media can be magnetic such as diskette, tape or fixed disk, or optical such as a CD-ROM. Additionally, the software can be supplied via the Internet or some type of private data network. A network device which typically runs the software includes a memory device, a protocol definition language, the parser, and the code generator. The functions of the protocol definition language, parser, and code generator are described above. The memory device has a protocol definition language database which contains a set of tables defining the data structure of the fields in the protocol data unit. Each of the set of tables has a set of data structure fields representing the data structure that a particular one of the fields may express. The particular one of the fields is associated with a particular one of the tables.

### BRIEF DESCRIPTION OF THE DRAWINGS

FIG. 1 is a block diagram of an embodiment of a protocol system for use with a network device which illustrates the connectivity of the devices comprising the protocol system.

FIG. 2 is a diagram which illustrates the OSI reference model of network architecture.

FIG. 3 shows an example of the network environment in which the present invention is used.

FIG. 4 illustrates the structure of a network frame.

FIG. 5 shows an encode flow diagram which illustrates the encode process of the present invention.

FIG. 6 shows a decode flow diagram which illustrates the decode process of the present invention.

FIG. 7 shows an emulator flow diagram which illustrates the emulation process of the present invention.

FIGS. 8A-8I is an embodiment of a protocol definition for the structure of the Internet Protocol.

FIGS. 9A-9E is an embodiment of a protocol finite state machine language description of the Link Control Protocol finite state machine.

FIG. 10 is a functional block diagram which illustrates the flow of data about the operation of a network into a network analyzer and host computer, each containing components of the present invention.

FIG.11 is a functional block diagram of the emulator component of the present invention.

FIGS. 12A-12B shows an example of a complete transition table for the Link Control Protocol finite state machine.

FIG. 13 is a functional block diagram of the parser/code generator component of the present invention.

FIG. 14 shows a monitor flow diagram which illustrates the monitor process of the present invention.

FIG. 15 illustrates a protocol definition language database containing compound field table which contains a soft link to a field table.

FIG. 16 illustrates a type table for the protocol definition language database.

FIG. 17 illustrates a finite state machine for code generation.

FIG. 18 illustrates a state hash table for the packet type field with corresponding code.

FIG. 19 illustrates an example of the source code generated for the packet type field.

FIG. 20 illustrates a portion of a protocol definition language database for a packet type field and router id field.

FIG. 21 illustrates an example of the protocol summary results.

FIG. 22 illustrates an example of the LCP status results.

FIG. 23 illustrates an example of possible events reported by the CPM Component through the user's browser window.

### DETAILED DESCRIPTION

I. Introduction

The following detailed description is divided into sections which have section titles to indicate the general nature of the information that follows. The sections and their titles are intended solely to assist in organization of the description and to aid the reader. They are not intended to indicate that information suggested by any one section title is not contained in any other section.

II. Overview of the Present Invention

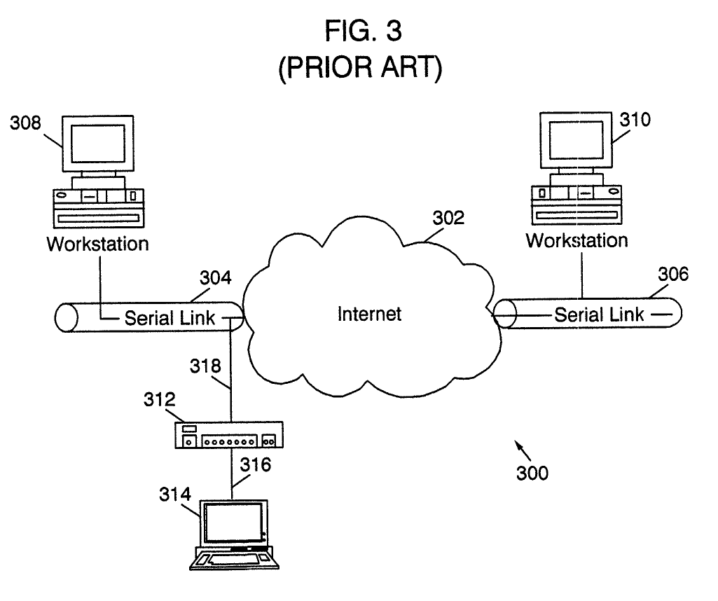

Referring to FIG. 3, which is a figurative illustration of a WAN 300, having the Internet 302, serial link communication mediums 304, 306, and workstations 308, 310. The WAN 300 may contain sub-networks, and is only intended in this description to illustrate a basic level of application. A network analyzer 312 and a host computer 314, as known in the art, is provided having the necessary hardware and software to capture, analyze, and monitor network frames. The network analyzer 312 is provided as an example of a network device requiring the functions of encoding network frames, decoding network frames, and the emulation of network traffic. The network analyzer 312 and host computer 314 is provided as an example of a device requiring the functions of providing a means of presenting control status and history to a user interface. The network traffic on the serial link communication mediums 304, 306 is in framed, serial digital bit format, a network frame. In practice, the host computer 314 may be local to, or remote from, the network. For local use, as depicted in FIG. 3, the host computer 314 is connected through its parallel port and cable 316 to a network analyzer 312. The network analyzer 312 is in turn connected through a network connection 318, or lines, to the serial link communication medium 304 of the WAN 300.

A network analyzer's monitoring, diagnostic, and problem resolution activities is under software control. Such software control is exercised by a main central processing unit (CPU), which is usually one or more microprocessors contained within the network analyzer 312 itself. The network analyzer 312 may also utilize a host computer 314 to facilitate user interface.

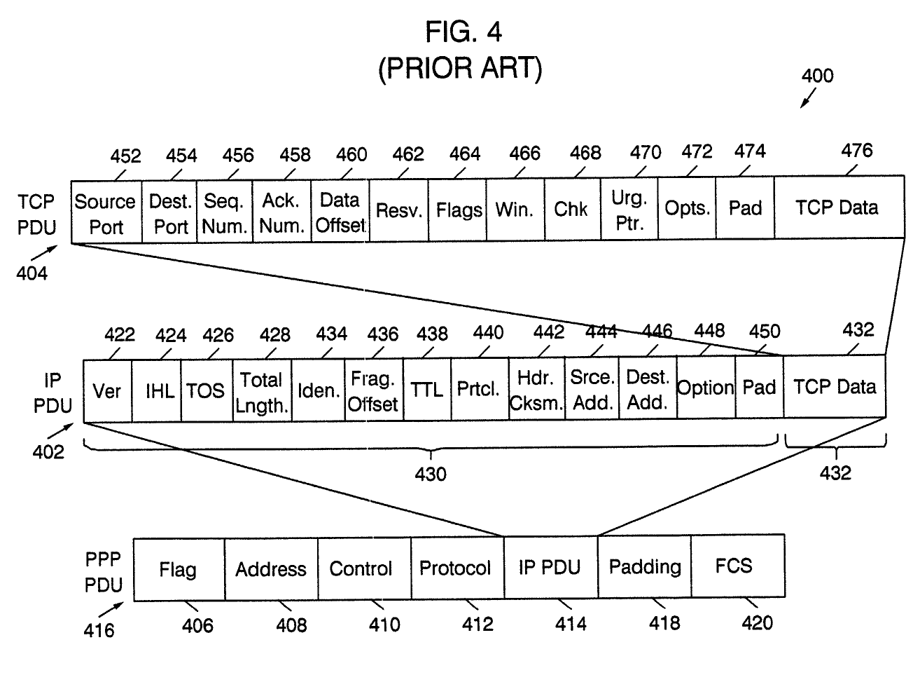

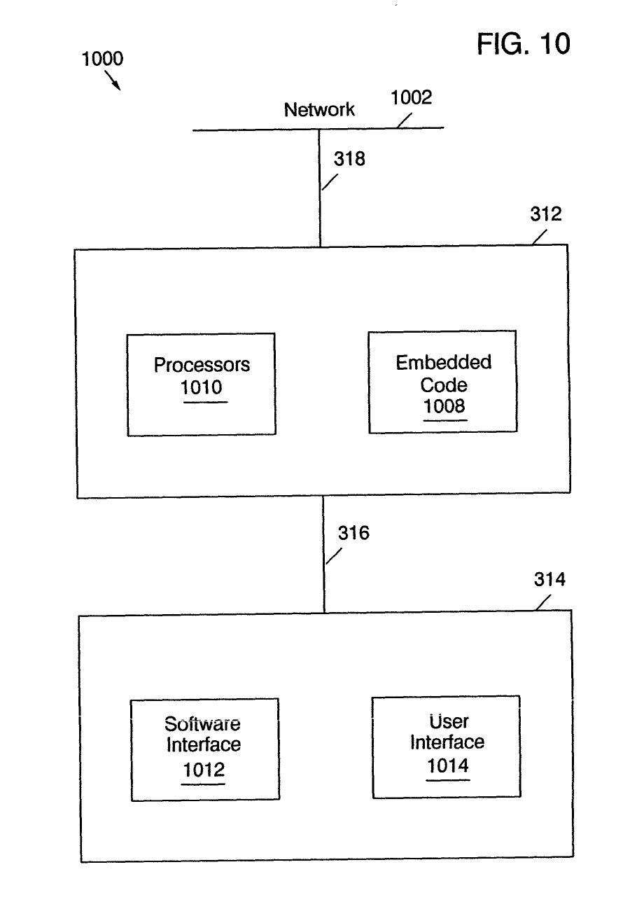

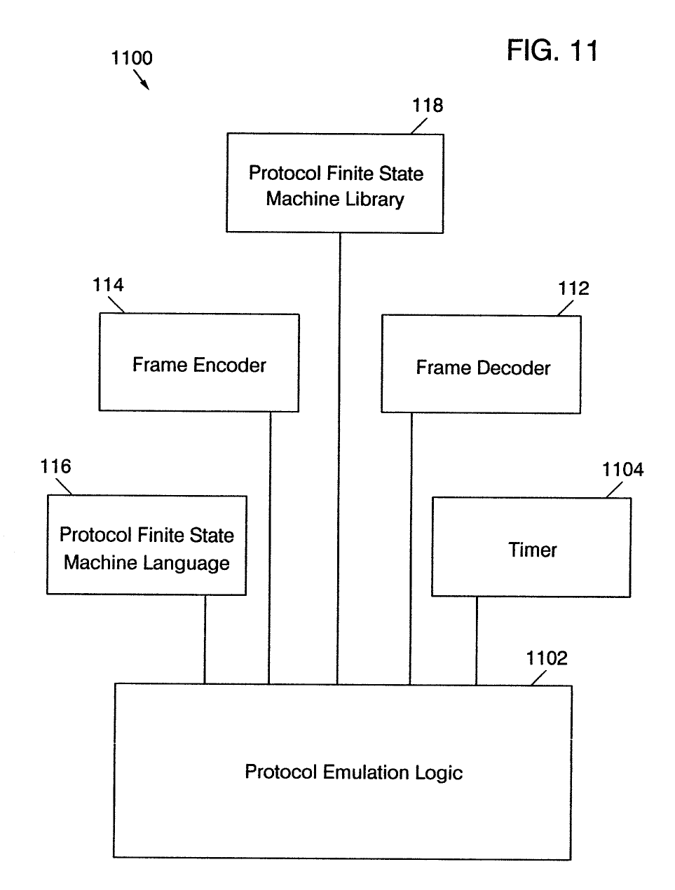

FIG.10 illustrates an overview of the flow of data 1000 about the operation of a network 1002 into a network analyzer 312 and host computer 314. Network frames, as illustrated in FIG. 4, are transmitted over the network 1002 and received for analysis by embedded code 1008 executed by the network analyzer 312 using its one or more processors 1010 and hard-wired analyzer circuits (not shown) within the network analyzer 312. The network 1002 is connected by a network connection 318. The results of the analysis are then available to be sent, as commanded by a user, to a software-based user interface 1012 running on the host computer 314 for storage and presentation to the user. The user interface 1014 then presents the analysis results to the user via the host computer's display device. The user interface 1014 also passes the user's commands (e.g., network parameters to be monitored, sampling rate, etc.) to the embedded code 1008.

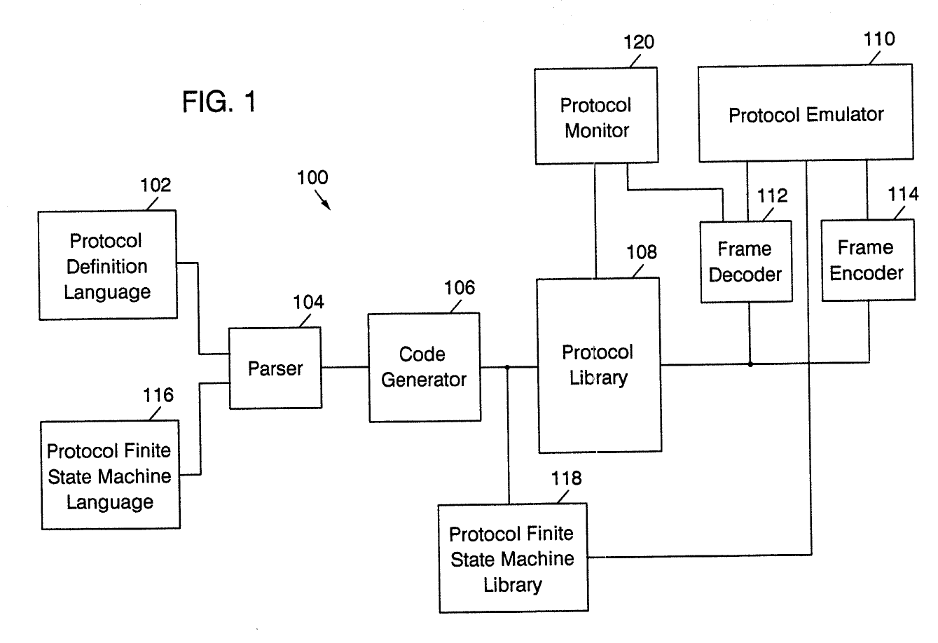

Referring to FIG. 1, which is a figurative illustration of a protocol system 100 for use with a network device such as the network analyzer 312 and host computer 314 of FIG. 10. The protocol system 100 may be loaded as part of the embedded code 1008 (FIG. 10) of the network analyzer 312 (FIG. 10). The protocol system 100 has a protocol definition language 102, a parser 104, a code generator 106, a protocol library 108, a protocol emulator 110, a frame decoder 112, a frame encoder 114, a protocol finite state machine language 116, a protocol finite state machine library 118, and a protocol monitor 120. The network analyzer 312 (FIG. 10) provides for network frame capture and transmission. Further information about network analyzers is set forth in the applicant's U.S. patent application Ser. No. 09/342,384 dated Sep. 21, 1999 for Real-Time Analysis Through Capture Buffer with Real-Time Historical Data Correlation.

Network analyzers 312 are capable of receiving user-selected network frames, storing network frames in a memory device for analysis by installed software or hardware, and transmitting network frames to the network. The protocol system 100 is implemented in software format in this embodiment, but may also be implemented in hardware format for installation on a network analyzer 312 or any other network device. The protocol system 100 provides for the decoding of received network frames into a generic, protocol-independent representation of the network frame as described in further detail below. Additionally, the protocol system 100 can convert such a representation or part of such a representation into a network frame for transmission to a network. Further, the protocol system 100 provides an emulation function by use of the frame decoder 112, frame encoder 114, protocol finite state machine library 118, and a timer, not shown. The protocol monitor 120 also provides for receiving decoded network frames containing control protocols from the protocol decoder 112 and presenting the protocol information to a user interface 1014.

The protocol definition language 102 defines keywords to describe any protocol in a generic representation. A user of the network device uses the protocol definition language 102 to define specific protocols, which are then converted into a computer language-specific representation using the parser 104 and code generator 106. These definitions are then stored in the protocol library 108. This enables the parser 104 and code generator 106 to be decoupled. The frame encoder 112 and decoder 114 use specific protocol information from the protocol library 108 for decoding and encoding specific network frames.

The frame decoder 112 may be used to decode captured network frames. The frame decoder 112 receives a network frame in digital format and creates a generic representation of the network frame. Similarly, the frame encoder 114 can be used the network device to encode a generic frame representation or part of such a representation into a network frame for transmission to a network. The frame decoder 112 and frame encoder 114 use the protocol library 108, having knowledge of specific PDU structure, to traverse the PDUs of a network frame, retrieve information on the content of PDUs, and extract information specified by the user.

The protocol system 100 provides for emulation which consists of defining finite state machines that contain stimulus events, responses to those events, and transitions among states. The protocol finite state machine language 116 defines keywords to describe finite state machines in generic representation. A network device user provides protocol-specific finite state machine information. This information is then converted into a computer language-specific representation using the parser 104 and code generator 106. Additionally, this information is stored in the protocol finite state machine library 118. Generic finite state machine code uses protocol-specific finite state machines from the protocol finite state machine library 118 while emulating a protocol. The protocol emulator 110 uses the finite state machine to identify stimulus events, track states, and respond with user-specified responses.

The protocol monitor 120 provides a means for analyzing the protocols embedded within a network frame and displaying protocol information on a user interface 1014. The protocol monitor 120 receives decoded network frames containing embedded protocols from the protocol decoder 112 and presents current protocol information and history to the user through the user interface 1014. Additionally, the protocol monitor 120 uses the protocol finite state machine library 118 for monitoring protocols.

III. Protocol Definition Language

The protocol definition language 102 provides a means for encapsulating knowledge of the structure of individual PDUs in a text representation, the American Standard Code for Information Interchange (ASCII) for example. The network device user may author a description of any protocol using the protocol definition language 102. This description includes the layout of the PDU in terms of header, data, and trailer. The protocol definition language 102 also provides a means of encapsulating knowledge of the fields contained in the header and trailer, if any, into an object format represented as keywords. The protocol library's 108 knowledge may include: the specific bit positions of all fields; how to calculate fields that are determined at runtime or depend on the contents of other fields; ability to specify variable length and recurring fields; description of fields; possible values of fields; PDU minimum and maximum sizes; and the payload minimum and maximum sizes. The protocol knowledge is stored in the protocol library 108 for access by the frame decoder 112 and frame encoder 114.

In one embodiment, the protocol definition language 102 uses objects, as in object-oriented technology, to generically represent the network frame to be described. Keywords are used to label objects as such. The network frame, the header, trailer, and payload of each protocol PDU, and the associated fields are represented as objects. Object-oriented technology (OOT) is used to represent network frames. Object-oriented technology decomposes a problem into a set of black box objects and depends upon the benefits of data hiding, inheritance, and polymorphism.

In this embodiment of the invention, a particular protocol to be defined is specified by the keyword “protocol”. The following syntax is used for defining a protocol:

protocol “protocol_name” {definition}

Protocol_name is the name of the particular protocol being defined. Definition is the section in which the protocol is defined, containing keywords further defining the protocol. The various fields of the protocol are defined within the definition section. The definition section can contain keywords for “len,” “minlen,” “maxlen,” “header,” “trailer,” “field,” “decisive_field,” “compound field,” “repeat,” and “switch” keywords as defined below.

The “header” keyword defines the protocol header. The following syntax is used for defining a protocol header:

header “header_name” {definition}

Header_name is the name of the particular protocol header being defined. Definition is the section in which the protocol is defined. The definition may contain the “len,” “minlen,” “maxien,” “field,” “decisive_field,” “compound_field,” “repeat,” and “switch” keywords as defined below.

The “payload” keyword defines the protocol payload. The following syntax is used for defining protocol payload:

payload “payload_name” {definition}

Payload_name is the name of the particular protocol payload being defined. Definition is where the payload is defined. The definition may contain the “len,” “minlen,” “maxlen,” “field,” “decisive_field,” “compound_field,” “repeat,” and “switch” keywords as defined below.

The “trailer” keyword defines the protocol trailer. The following syntax is used for defining a protocol trailer:

trailer “trailer name” {definition}

Trailer_name is the name of the particular protocol trailer being defined. Definition is the section in which the protocol is defined. The definition may contain the “len,” “minlen,” “maxlen,” “field,” “decisive_field,” “compound_field,” “repeat,” and “switch” keywords as defined below.

The “protocol,” “header,” “payload,” and “trailer” keywords are more particularly defined using the “len,” “minlen,” “maxlen,” “field,” “decisive_field,” “compound field,” “repeat,” and “switch” keywords.

The “len” keyword specifies the length, or size, of the following keywords: “protocol,” “header,” “trailer,” “payload,” “field,” “decisive_field,” or “compound_field”. Either of the following two syntaxes may be used for defining a protocol trailer:

len=value

len=eval_fn(function_name, arg1, arg2 . . . )

“Len” can equal an integer value or a function. Value represents the length in number of bits. Value can be any arithmetic expression that evaluates to an integer. Eval_fn represents length as a function with different argument variables.

The “minlen” and “maxlen” keywords specify, respectively, the valid minimum and maximum lengths, or bit size, of the “protocol,” “header,” “trailer,” “payload,” “field,” “decisive_field” or “compound_field” keywords. The following syntax may be used for defining minimum and maximum field lengths:

minlen=value

maxlen=value

The length is measured in bits and represented by value, any arithmetic expression that evaluates to an integer.

Keywords “minvalue” and “maxvalue” specify the minimum and maximum value of a field respectively. The following syntax may be used for defining minimum and maximum valid values of a field:

minvalue=value

maxvalue=value

“Minvalue” and “maxvalue” are measured in number of bits. Value can be any arithmetic expression that evaluates to an integer.

Keyword “field” is the lowest keyword for describing a protocol. It cannot contain compound fields, decisive fields or other fields. The following syntax may be used for defining fields:

field “field_name”

field “field_name” {definition}

Field_name indicates the name of the protocol field being defined. The definition section can contain “len,” “minlen,” “maxlen,” “minvalue,” and “maxvalue” keywords to describe the field.

A field may also be described by keywords “desc,” “field_type,” “default,” “possible_values,” and “optional”.

The “desc” keyword may be used as a string description of the field. This serves as a comment section for users.

The protocol system 100 allows the user to create network frames for transmission to the network using the frame encoder 114. The “field_type” keyword is used for describing a field for network frame encoding. The following is a list of values for the “field_type” keyword: “must_encode,” “mulopt_prtcl_fld,” “mulopt_msg_fld,” and “mulopt_other_fld”. The “must_encode” value specifies that the field is a mandatory field and that the user must specify the field value during encode. If the field has both “must_encode” and “default,” as described below, the default property is ignored. The “mulopt_prtcl_fld” keyword specifies that the field is a protocol field, a field in a network frame identifying the next layer protocol. The “mulopt_msg_fld” keyword specifies that the field is a message field. The value of the field specifies the message. The “mulopt_other_fld” keyword specifies that the field is a multiple option field other than protocol and message field.

The “default” keyword is used for frame encoding. The “default” keyword is used to identify the default value of the field being defined. When the user does not provide a value for this field during encode, the default value is provided by the protocol system 100. If both “default” and “must_encode” properties are absent, the default value of the field is assumed to be the integer 0. If the field has both “must_encode” and “default” property, “default” property is ignored. The default value may be an integer, string or function. The following is the syntax of default when value is specified as a function:

default=eval_fn(function_name, arg1, arg2 . . . )

Eval_fn represents length as a function with different argument (arg) variables.

The keyword “display” specifies the display property of the field. The value of the “display” keyword specifies how the field should be displayed on the user interface 1014 for monitoring. Bit, decimal, and hexadecimal are examples of how the field may be displayed.

The keyword “possible_values” specifies the valid set of values and optional value description. “Possible_values” may be nested. If the expression is absent, then the value of the current field is assumed.

The keyword “optional” indicates that the specified field is an optional field. If the optional property is absent, the field is mandatory. Logical expressions are used to specify the condition for the presence of the field. The following is a list of the logical operators for use in the logical expression: less than (<), greater than (>), equal to (=), less than equal to (<=), and greater than equal to (>=).

The “decisive_field” keyword provides an ability to define a constant portion of the protocol. The “decisive_field” keyword does not describe a portion of the protocol and is not part of decoded or encoded protocol. It enables the protocol system 100 to determine and describe the protocol based on its value at runtime. It may not contain the keywords “compound_field,” “decisive_field,” or “field”. The syntax for “decisive_field” keyword is the same as “field” keyword as described above.

The “compound_field” keyword provides an ability to embed multiple levels of “compound_fields,” “repeat,” “decisive_fields,” and “field” keyword. The following is the syntax for the “compound_field” keyword:

compound_field “compound_field name” {definition}

Compound_field name specifies the name of the “compound_field”. The definition section may contain “len,” “minlen,” “maxlen,” “field,” “decisive_field,” “compound_field,” “repeat,” and “switch” keywords. The definition may also contain “desc,” “display,” and “optional” properties.

The “repeat” keyword provides the ability to specify recurring fields. The two syntax used for the “repeat” keyword follows:

repeat {definition}

repeat (count) {definition}

Definition contains the definition of recurring compound fields and fields. Definition is repeated multiple times for the entire length of the PDU. The definition section can contain “field,” “compound_field,” “repeat,” “switch,” “break,” and “len” keywords. The “break” keyword provides for early exit from the repeat loop. The count is an integer number specifying the number of times to repeat the definition.

The “switch” keyword provides the ability to execute different program routines based on the contents of the field. The syntax for the “switch” keyword follows:

switch (expression) {

case_value1: stmt1

case_value2: stmt2

. . .

default: stmtn

}

Expression can be any arithmetic expression that evaluates to an integer. “Switch” keyword evaluates the expression in the parenthesis and compares its value to all the cases. If a case matches the expression value, the matched expression value is selected. The case labeled “default” is executed if none of the other cases is satisfied and the default case is present. If the “switch” keyword does not contain an expression in parenthesis, the value of the current field is compared to all cases.

The “valueof” keyword provides for the calculation of fields that are determined at runtime or depend on the content of other fields. This keyword is also used to obtain value of the field specified by field_name. The syntax for the “valueof” keyword follows:

valueof (field “field_name”)

Field_name is the name of the field. Field_name must be defined prior to its usage in “valueof” keyword.

IV. Protocol Library

The protocol library 108 contains knowledge of the structure of the protocol data units in a network frame. A user defines a protocol data unit given the syntax of the protocol definition language 102 and a description of the specific protocol. The protocol library 108 has knowledge of the structure of the protocol data unit of a defined protocol which may include: the specific bit positions of all fields; how to calculate fields that are determined at runtime or depend on the contents of other fields; ability to specify variable length and recurring fields; description of fields; possible values of fields; protocol data unit minimum and maximum sizes; and the payload minimum and maximum sizes. The protocol knowledge is stored in the protocol library 108 for access by the frame decoder 112 and frame encoder 114.

Referring to FIG. 4, a typical network frame, a WAN frame 400, is shown. For illustrative purposes, the WAN frame 400 shown is a Point-to-Point Protocol (PPP) network frame, having Internet Protocol (IP) 402 and Transmission Control Protocol (TCP) 404 PDUs embedded. The WAN frame 400 includes, with respect to increasing time, a flag field 406, an address field 408, a control field 410, and a protocol field 412. The protocol field 412 identifies the next type of protocol embedded within the WAN frame 400. In this illustration, the next higher protocol layer is Internet Protocol which is embedded within the WAN frame 400. The IP PDU 402 is contained in the payload 414 of the PPP PDU 416. The remaining fields in the trailer are the padding field 418 and the Frame Check Sequence field 420.

An IP PDU 416 is illustrated as a PDU embedded in a WAN frame 400. IP is a basic building block protocol for the Internet. The IP will sometimes break a larger message into datagrams for transmission over the Internet. The datagrams are reassembled into the original, larger message upon reaching their destination. The IP functions to transport datagrams from source to destination whether or not the network devices are on the same network or whether there are networks between them. The IP provides the functions necessary for the network layer 211. The IP is called on by host-to-host protocols, such as Transmission Control Protocol, in an Internet environment. The version field 422 indicates the version of the Internet Protocol to which the Internet Protocol PDU 402 belongs. IHL 424 indicates the Internet Protocol PDU header length. The type of service field 426 indicates the quality of service desired. Total length 428 indicates the length of the frame, which includes the header 430 and payload 432 portions of the Internet Protocol PDU 402. Identification 434 and fragment offset 436 are used in reassembling fragments of a message. Time to Live (TTL) 438 indicates the maximum time that the Internet datagram can remain in the network system. Again, protocol 440 indicates the next layer protocol used in the payload portion 432. In this illustration, the payload portion 432 contains a TCP PDU 404. Header checksum 442 is used for error checking. Source and destination addresses 444, 446 indicate the source and destination for transmitting the datagram respectively. Option 448 may or may not appear in datagrams. The option is what particular datagram to transmit. The padding field 450 is used to “space” the frame to meet length requirements.

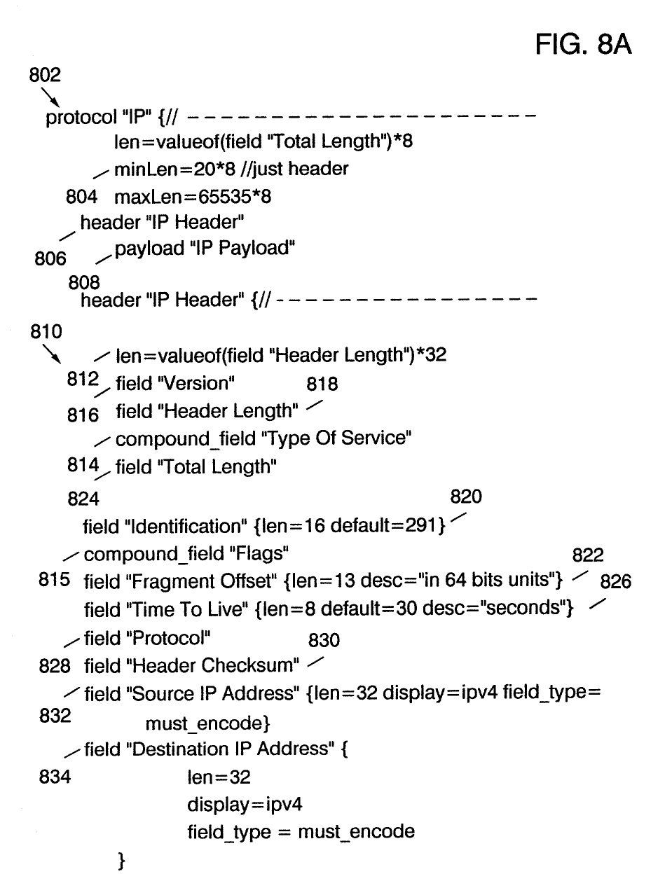

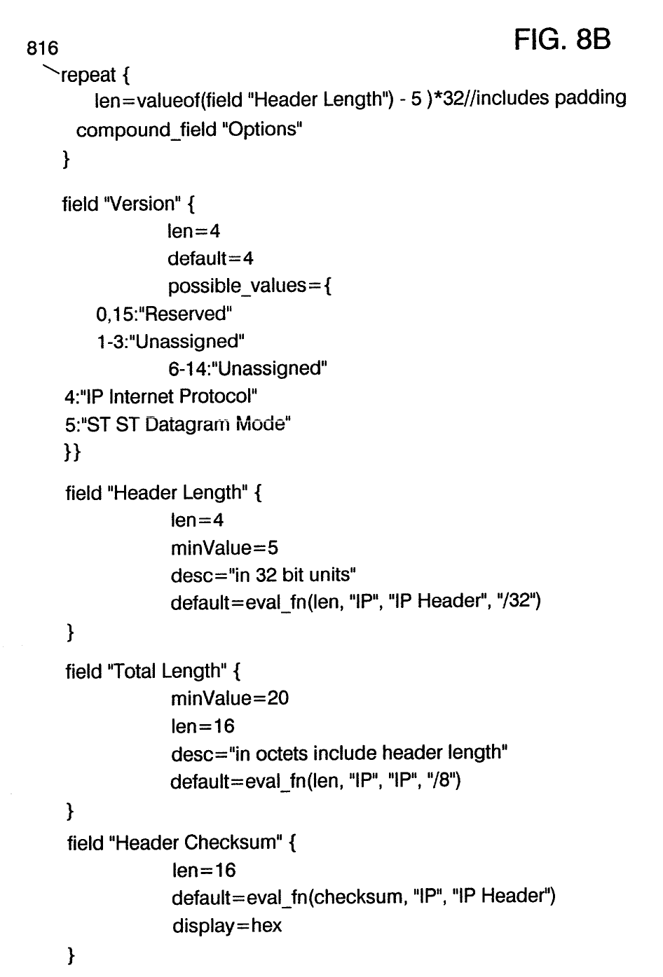

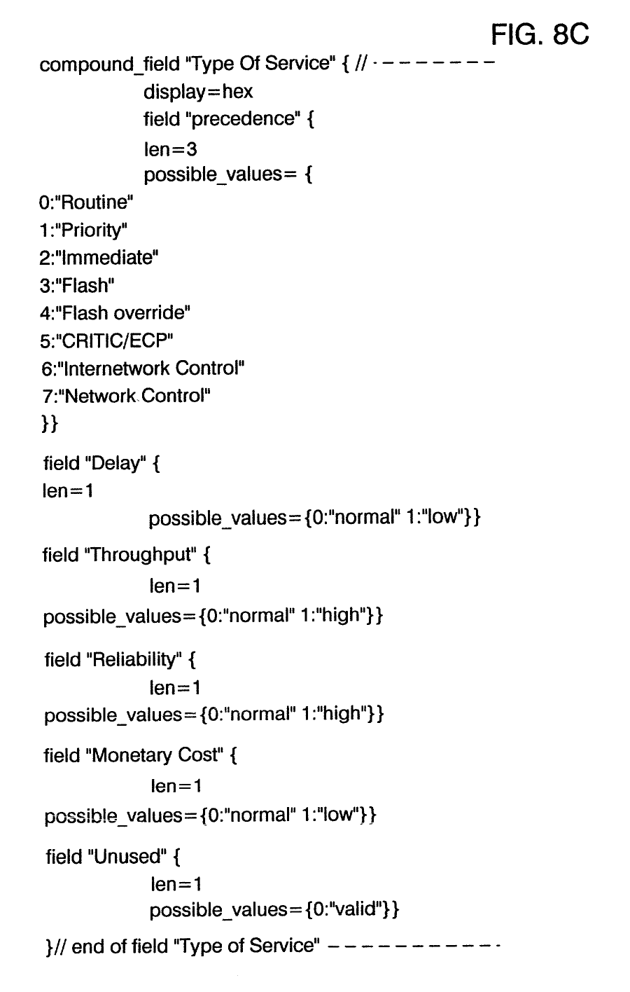

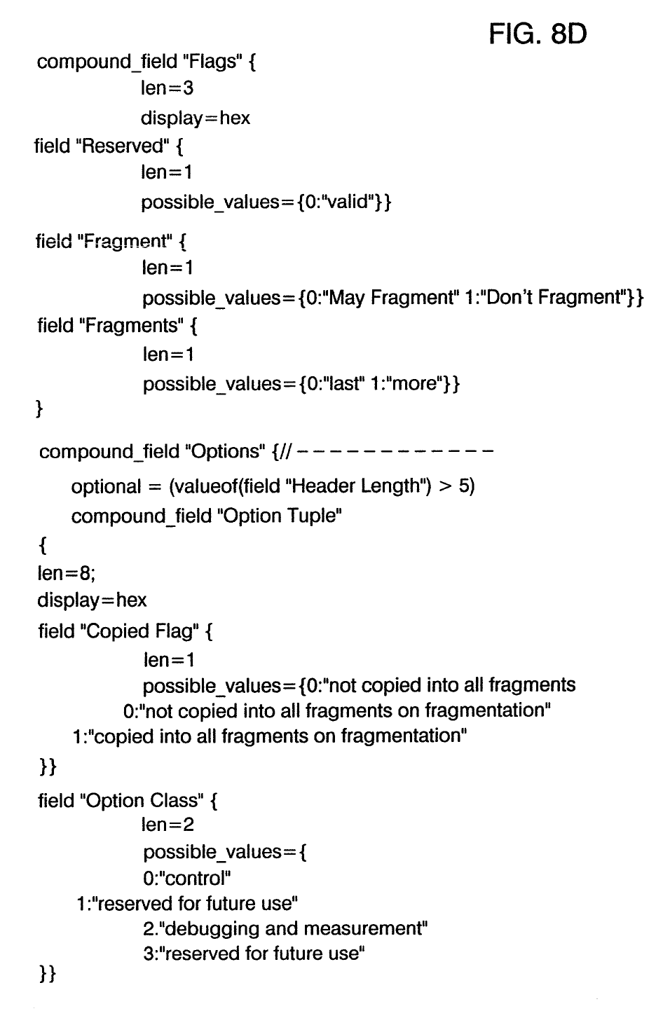

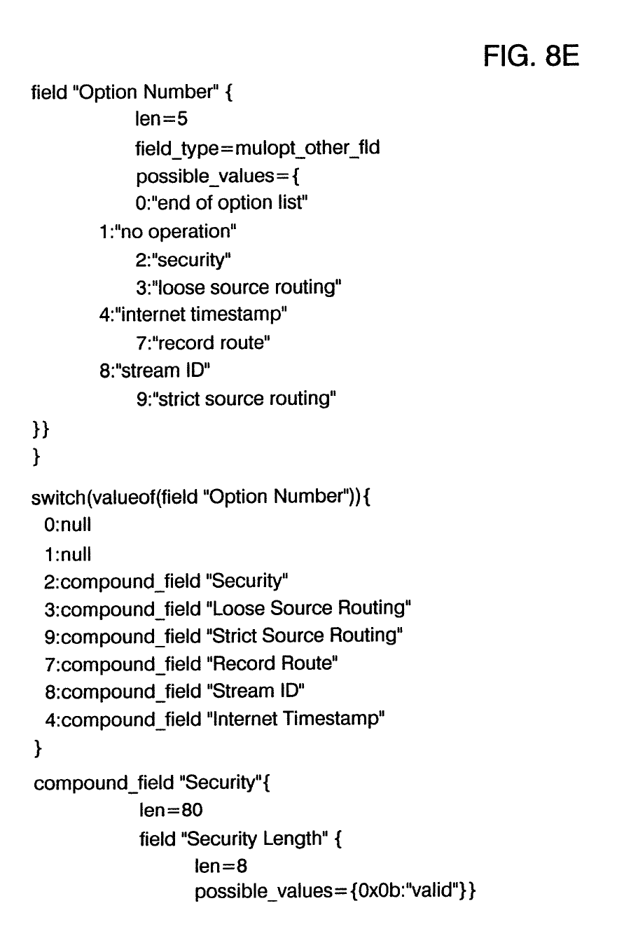

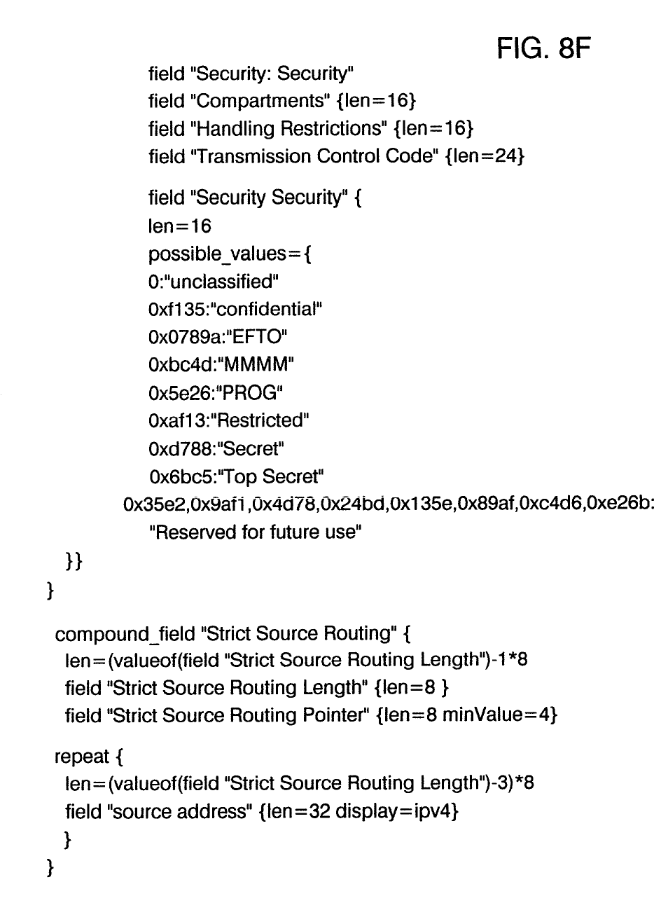

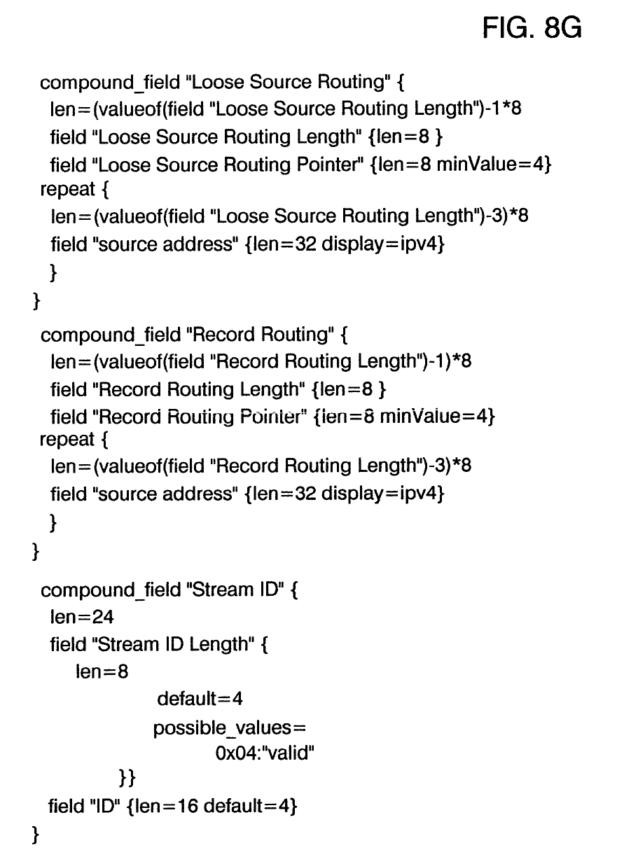

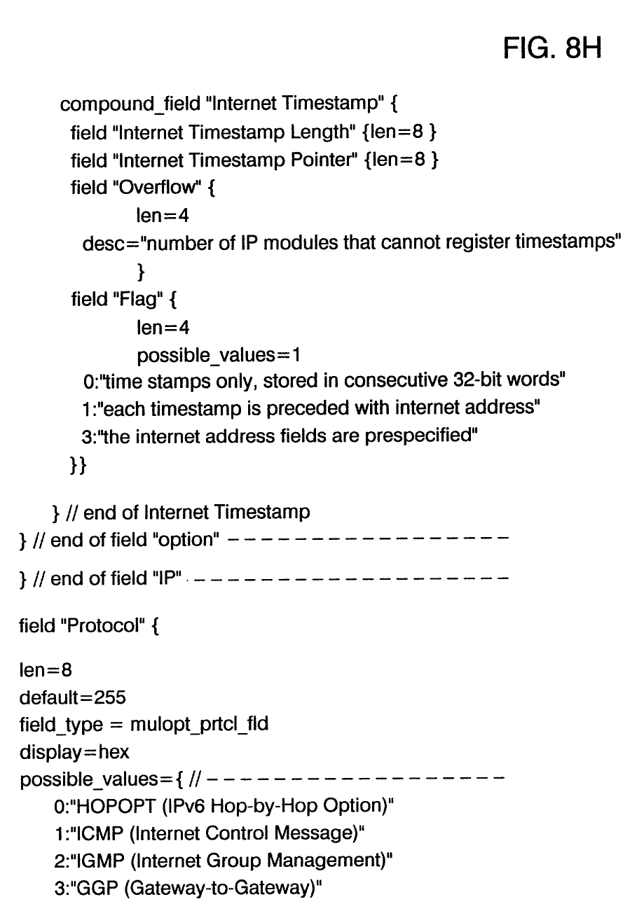

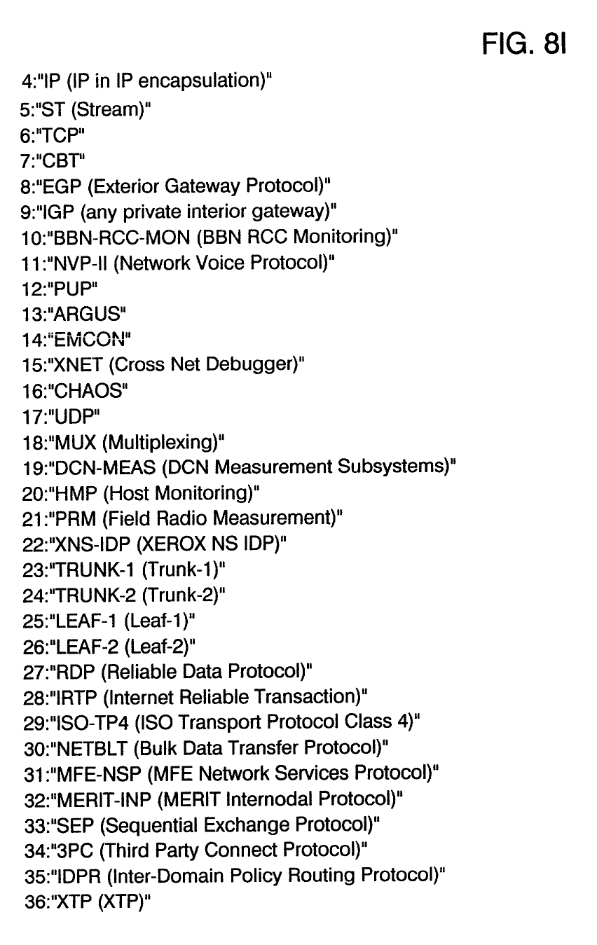

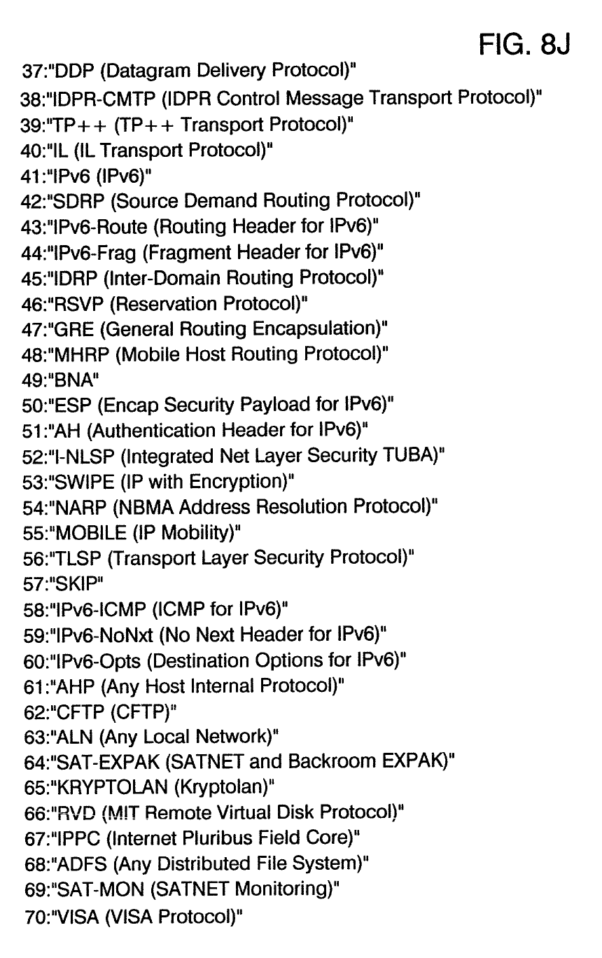

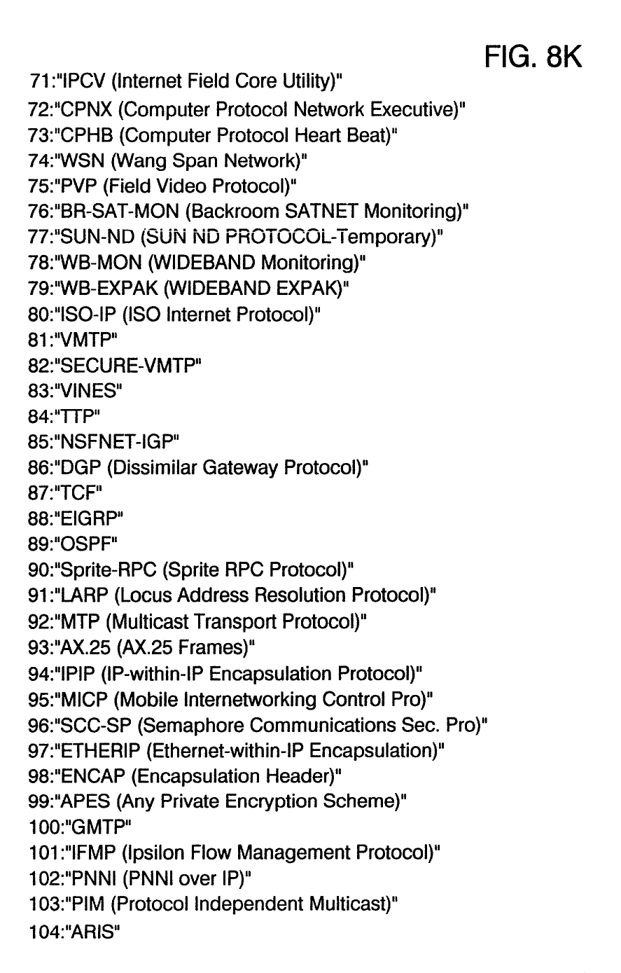

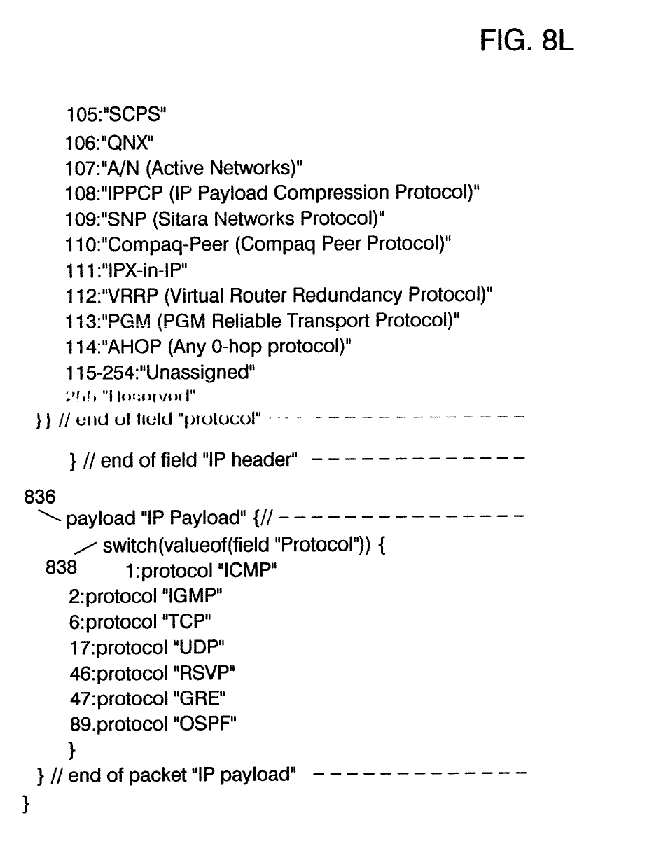

Referring to FIGS. 8A-8I, a protocol definition language description is provided for the structure of an Internet Protocol PDU. In the appropriate syntax, as described above, the protocol_name is “IP” 802 (FIG. 8A). The keywords “len,” “minlen,” and “maxlen” are used to define the length of the IP PDU 804 (FIG. 8A). The keywords “header” 806 and “payload” 808 (FIG. 8A) are included in the protocol definition so that they may each be defined elsewhere. The “header” keyword is defined at 810 (FIG. 8A) and described with “len” 812, “field” keywords (816, 818, 820, 822, 824, 826, 828, 830, 832, 834), “compound_field” (814, 815), and “repeat” keywords 816. Each of the fields within the IP header are defined 816, 818, 820, 822, 824, 826, 828, 830, 832, and 834. The payload “IP Payload” 836 (FIG. 81) is also defined using the keyword “switch” 838.

Again referring to FIG. 4, the TCP PDU 404 is embedded within the IP PDU 402. The source and destination fields 452, 454 indicate the source and destination ports respectively. Next, the TCP PDU 404 contains sequence number 456, acknowledgement number 458, data offset 460, reserved 462, flags 464, checksum 468, urg. ptr. 470, options 472, padding 474 fields, and TCP Data for payload 476.

As provided for IP in FIGS. 8A-8I, a protocol description may be provided for TCP and PPP in the protocol definition language 102. With a description of the appropriate protocols, a network frame may be fully described in the protocol definition language 102. The value of the frame fields may be easily referenced in a memory device by decoding the received network frame and storing the field values with the appropriate keywords in a frame decode.

V. Decode Process

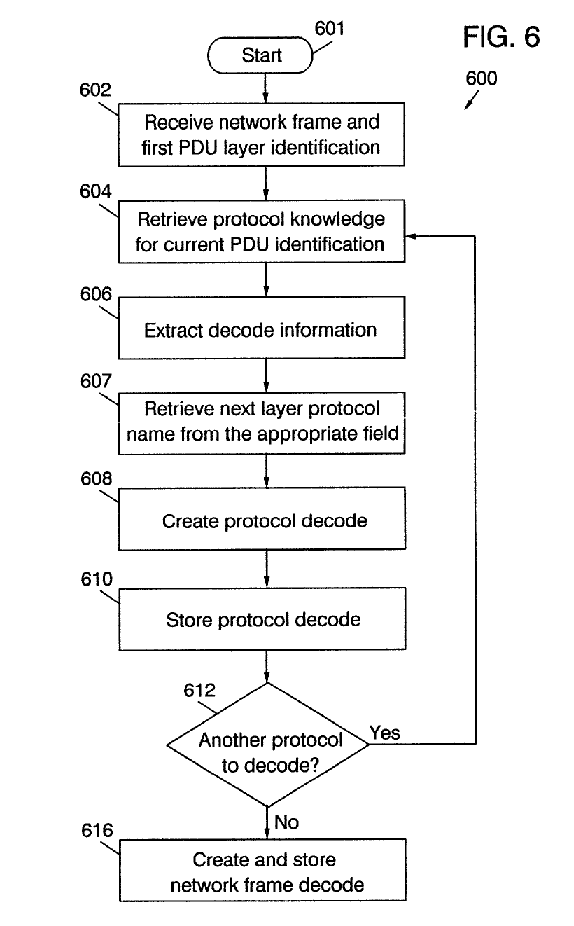

The frame decoder 112 is capable of receiving a network frame as input and, given knowledge of the protocols in the network frame as provided by the protocol library 108, perform a full, generic decode of the network frame. Referring to FIG. 6, a figurative illustration of a decode process 600 is provided. The decode process 600 provides a method of decoding network frames for monitoring and analysis. The decode process 600 begins with the start step 601. After the start step 601, a network frame and a first protocol layer identification are received 602. The first PDU layer identification is provided by the network devices which has knowledge of the name of the first protocol layer that it is receiving from a network. In the case of the WAN frame 400 of FIG. 4, the PDU identification is PPP, which is the first protocol layer of the protocol stack. The first PDU layer identification provides the decoding process with a starting point for decoding. After each protocol is decoded, the next PDU layer identification becomes the current PDU layer identification until all protocols have been decoded.

Based on the current PDU layer identification, the protocol library 108 is searched and the protocol information as encapsulated by the “protocol” keyword matching the current PDU identification is retrieved 604. The retrieved protocol information, containing knowledge of the structure of the PDU associated with the current PDU identification, is used by the frame decoder 112 to decode the current PDU layer 608.

The protocol system 100 decodes the current protocol layer by traversing the network frame's current PDU layer header and trailer 608 for field information as specified by the retrieved protocol information for the current PDU identification. The retrieved protocol information includes knowledge of the size and location of the fields in the network frame. The extracted decode information is put into a format, a protocol decode, to be accessed by the network device user or the protocol emulator 110 from memory storage on the network device or computer-readable medium.

On encountering the header of the current protocol, the decoder extracts decode information from the header and trailer of the current PDU layer based on the fields that need to be filled 606. The type of decode information retrieved 604 from the protocol library 108 for the header decode includes: field names; field lengths; the field offsets in the current frame; display properties which specify how the fields should be displayed on the GUI; and the decode information for fields that are contained in the header, trailer, or payload. The field offset and field length indicates to the frame decoder 112 where the bits for a certain field are located in the network frame. The information extracted from the network frame is used to create a protocol decode 608, and, once the entire protocol stack is decoded, a network frame decode. The extracted information in the header is stored in a memory component of the network device or a computer-readable medium in the header decode 610. The information for the trailer is extracted in the same way and stored in the trailer decode 610. Information is also retrieved from the appropriate field identifying the next layer's protocol name 607. In the IP PDU 416, this is in the protocol field 434. This information is later used for decoding the next layer in the protocol stack.

In the same manner, information is retrieved from the network frame for any compound fields defined by the protocol library 108 for the current PDU layer. The decoder stores the following decode information in the compound field decode: field names, field lengths, field offsets in the current frame, display properties which specify how the field should be displayed, and decode information for other fields that the compound field contains. The compound field decode is the container for holding fields, decisive fields, and compound fields. The frame decoder 112 traverses through all of the fields in the PDU and stores the gathered information in a memory component of the network device or a computer-readable memory.

For the decisive field decode, the decoder evaluates the decisive field value. The decisive field is helpful in decoding the frame. Typically, the value of the decisive field is used later by the decoder to decode other fields.

For the repeat decode, decoder creates repeat field decode. It holds repeated field decodes or compound field decodes. Terminating condition for repeated field/compound field is provided by break condition or by total repeated length. The decoder uses repeat decoder to facilitate evaluation and determination of terminating condition.

For the field decode, the decoder stores the following decode-related information in field decode: field name, field length, field offset in current frame, display properties which specify how the field should be displayed on the screen, additional description that would provide useful information to the user, field value from current frame, and string descriptions of the current frame. Field information may contain a list of string descriptions of all possible values that the field may have. The decoder uses the possible value decoder to obtain string description of field value. The decoder validates current field value against minimum and maximum value constraints, provided minimum and maximum value constraints are present in the protocol information. If the field value is not valid, error is noted in the field decode.

The frame decoder 112 uses the following helper decoders to decode a frame: possible value decoder, default decoder, value of decoder, function decoder, logical decoder, optional decoder, multiple option decoder and repeat decoder.

The possible value decoder, given the current field value, retrieves and provides the corresponding string description to the frame decoder 112. Field information contains the valid set of possible values and corresponding string description. String description of field value provides user-friendly, human readable information compared to integer value.

The field information of the default decoder specifies the default value of a field. Default value can be an integer, string or function and is used both for encodes and decodes. If the field holds checksum value, then the decoder uses default decoder to evaluate the checksum value for the protocol. In case of checksum, the default value is always specified with function name followed by the list of function arguments. Code for the function is provided by the user of the protocol library 108 in a known file with the same function name. The default decoder uses the function decoder to evaluate function. Function decoder gets the function name and invokes the function in known file with the provided arguments. Function calculates checksum of the protocol with the user-provided code and returns calculated checksum value. The calculated checksum is then noted and saved with generated field decode. This calculated checksum can later be displayed on the user interface 1014 or compared with actual protocol checksum value in the network frame to see if the frame contains valid checksum.

The valueof decoder contains the “valueof” keyword which is used to obtain the value of the field specified by the field name. Value is determined at runtime based on the contents of the frame. Typically, protocol information contains “valueof” keyword as part of arithmetic expression which evaluates to an integer. Value of decoder decodes and obtains “valueof” field specified by “valueof” keyword. It evaluates arithmetic expression involving boolean and, boolean or, addition, subtraction, division, and multiplication along with decoded valueof field value and returns an integer value.

The function decoder is used when the user specifies the default value or length by providing function name followed by list of function arguments. Code for the function is provided by the network device user. Function decoder gets function name and invokes the function with the provided arguments. Function decoder calculates default value or length with user-provided code and returns the calculated value.

The logical decoder is used when the protocol information uses a logical expression to evaluate whether the field or compound field is optional. Also, Break uses logical expressions to specify terminating repeat condition. Typically, one of the operands in logical expression is valueof field. Logical decoder uses valueof decoder to evaluate valueof field. Then it evaluates logical expression involving the returned value from valueof field and logical operators such as less than (<), greater than (>), equal to (=), less than equal to (<+), and greater than equal to (>+) and returns a boolean (true/false) value.

Optional decoder is used to evaluate whether field or compound field is optional or not. The optional decoder evaluates the logical expression to determine the presence of a field.

Protocol information provides the ability to specify either multiple fields or compound fields. Selection of one of the fields or compound fields is defined by arithmetic expression which is dependent on the value of previously defined field. Multiple option decoder evaluates selection arithmetic expression using value of decoder and returns an integer value. Multiple option decoder, based on evaluation of arithmetic expression for current frame, selects field/compound field.

In the protocol information, field or compound field can be repeated. Terminating condition for repeated field or compound field is provided by break condition or by total repeat length. Repeat decoder evaluates terminating condition after each repeat. If false, field/compound field is repeated. Repeat decoder uses logical decoder to evaluate break condition. Also, repeat decoder checks whether the thus far repeated length is less than the total repeat length specified in protocol information. The repeat decoder will continue until the total repeat length is met.

Once the protocol PDU has been fully decoded, the protocol decode is stored 610 in memory component of the network device or a computer-readable medium. Upon decoding, the current protocol provides the next protocol layer identification in an appropriate field. If there is another protocol to be decoded 612, protocol information is retrieved 604 based on the retrieved protocol name for the next layer 607 and the process of traversing the network frame 608, retrieving the next protocol layer name 607 (if available), and creating protocol decode 608 begins again. This process continues until there are no more protocols to decode. Then the network frame decode is created and stored by compiling all of the decodes 616.

VI. Encode Process

The protocol system 100 is capable of creating a network frame for network transmission network by encoding network frame data, having protocol stack information and field data. Protocol stack information consists of the names of the protocols to be stacked in the network frame and the order in which they to be stacked. Field data consists of the values of the fields in the network frame and information identifying the fields in which they are to be placed. Additionally, the protocol system 100 is able to create a raw stream of bytes representing a single PDU for a specific protocol given that protocol's definition.

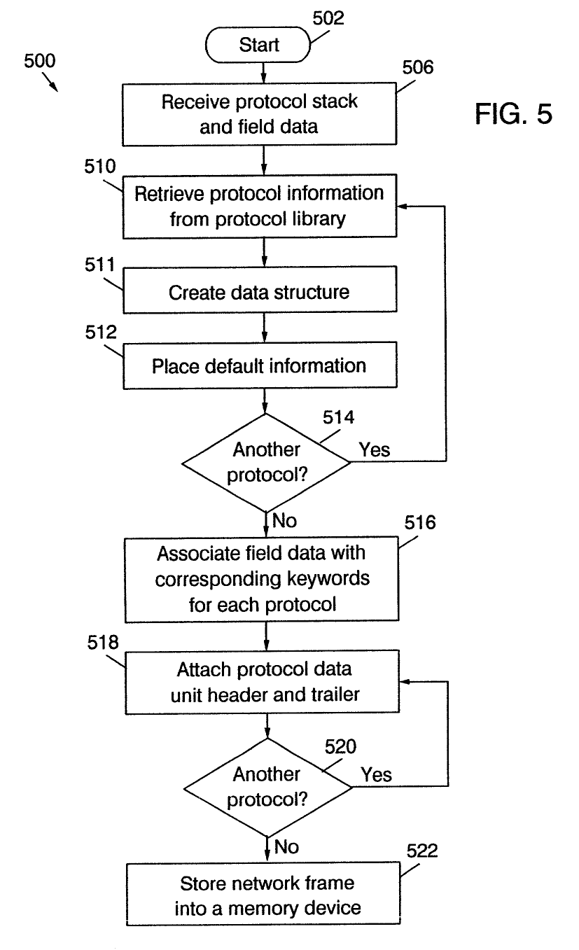

Referring to FIG. 5, a figurative illustration of an encode process 500 is provided. The encode process 500 provides a method of receiving network frame data and encoding it for transmission to the network. The encode process 500 begins with the start step 502. After the start step 502, the protocol stack information and field data is received 506.

Given the names of the protocols to be stacked in the network frame, the protocol knowledge for the first protocol in the protocol stack information is retrieved 510 from the protocol library 108. Protocol knowledge includes knowledge of the structure of the PDU for the named protocol. The protocol knowledge of the library includes all knowledge as described above, for example, header keywords, trailer keywords, payload keywords, and field keywords associated with the header and trailer keywords. Given the knowledge of a specific PDU, a data structure is created 511. As described above, the protocol library 108 contains the default information for certain fields. Default information provided by the protocol library 108 is placed into the appropriate fields of the data structure. Default information provides the value for a keyword when field data is not provided for the keyword.

At step 514, the frame encoder 114 determines whether there is another protocol layer in which to retrieve information. This continues until it is determined that there are no more protocols to retrieve 514.

Next, the field data is associated with the corresponding keywords for each PDU as defined in the protocol definition 516. Default information for any field is replaced by any field data for that particular keyword. The PDU headers and trailers, if any, are then attached one-by-one according to the order in the protocol stack information in steps 518 and 520 until there are no more protocols. Attaching the headers and trailers in this manner creates a network frame. This network frame is then stored in a memory storage on the network device or some computer-readable medium 522 according to protocol stack information and knowledge of the protocol data units.

VII. Protocol Finite State Machine Language

The protocol finite state machine language 116 provides a means of describing the finite state machine (fsm) of network protocols in a text representation. The network device user may author a description of any protocol using the protocol finite state machine language 116. This description includes the structure of the finite state machine in terms of states, events, and actions. A finite state machine contains several states in which state change is invoked by an event. The event may produce different effects, depending on the current state. For this reason, the state machine is organized by states and events that can occur in those states. Typically, an event is the receipt of a network frame and other events may be user-generated network link events, such as whether the network link is up or down or whether the user wants to start or stop emulation. An event entry may result in an action and change of state, simply a change of state, or neither an action nor change of state.

Similar to the protocol definition language 102, the protocol finite state machine language 118 encapsulates knowledge of a protocol finite state machine in a text representation. States are defined to generically represent the finite state machine and its components.

In this embodiment of the invention, a particular finite state machine is specified by the keyword “fsm”. The following syntax is used for defining a finite state machine:

fsm “fsm_name” {description}

Fsm_name is the name of the particular fsm being defined. Description is the section in which the fsm is defined, describing the states, network events to which the fsm responds, and actions of the fsm.

The “state” keyword describes a state of the fsm. The following syntax is used for defining a state:

state “state_name” {description}

State_name is the name of the particular state being defined. Description is the section in which the state is defined.

The “event” keyword specifies the event that causes a state transition. Each event entry specifies an action routine, the next state, and an optional transition condition. The following syntax is used for defining an event:

event event_name action_routine next_state optional_transition_condition

The event_name is the name of the particular event that causes a state transition. An event may be one of several types of events that occur which is recognized by the fsm. For example, the user may indicate that the fsm is to stop. Such an action may be programmed on the protocol system to be an event. The fsm may then recognize such an event. Another event may occur on the receipt of a network frame. For example, a field of the network frame may indicate that the physical link to another network device is down. The network device may recognize this and indicate it to the fsm as an event.

The action_routine is the name of the routine that runs when the event_name occurs during the associated state. This routine is implemented in user provided code in the emulator. An action may be a routine to run for the creation and transmission of a network frame to the network. The next_state is the name of the next state of the fsm when the event_name occurs during the associated state.

Optional_transition_condition is an optional field. The transition condition is a boolean condition with action routine and value (value=transition_action_routine). The fsm, on receiving an event, checks for a transition condition. If transition_condition is true, then action_routine is executed and the fsm transitions to the next state. Otherwise, the fsm remains at the current state and does not run an action routine.

VIII. Protocol Finite State Machine Library

Referring to an embodiment of the invention in FIG. 1, a protocol is emulated by using a protocol finite state machine library 118. The network device user selects a protocol to emulate from the protocol finite state machine library 118. Protocol finite state machines for protocol emulation may be created by use of the protocol finite state machine language 116.

The protocol finite state machine language 116, as described above, provides a way to describe the user-provided finite state machines contained in the protocol finite state machine library 118 in a language-independent way. A finite state machine consists of a number of states in which state change is invoked by some event related to traffic on the network. The event may produce different actions, depending on the current state. The finite state machine language is organized by current state and events that can occur in that state. Each event entry describes the resulting new state and the set of additional actions.

The protocol finite state machine library 118 contains the descriptions of finite state machines. The user of the protocol system 100 defines the finite state machines contained in the protocol finite state machine library 118.

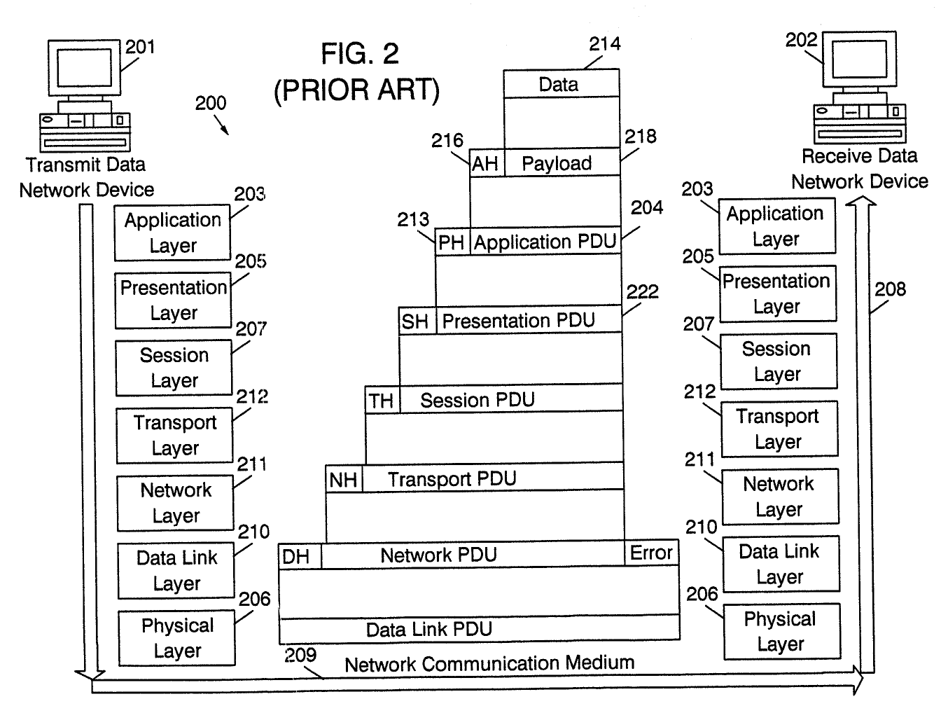

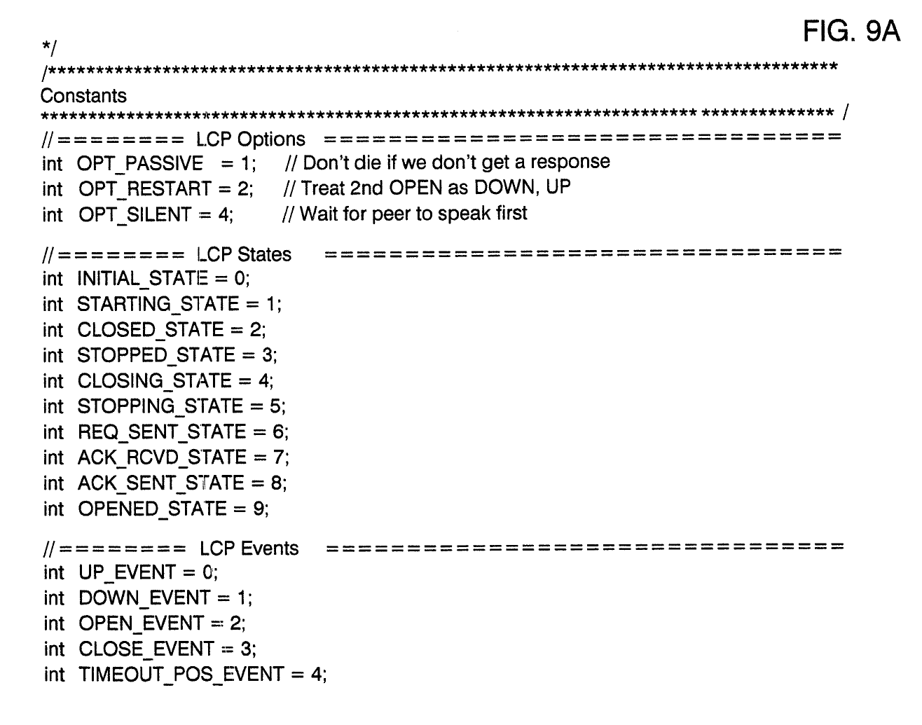

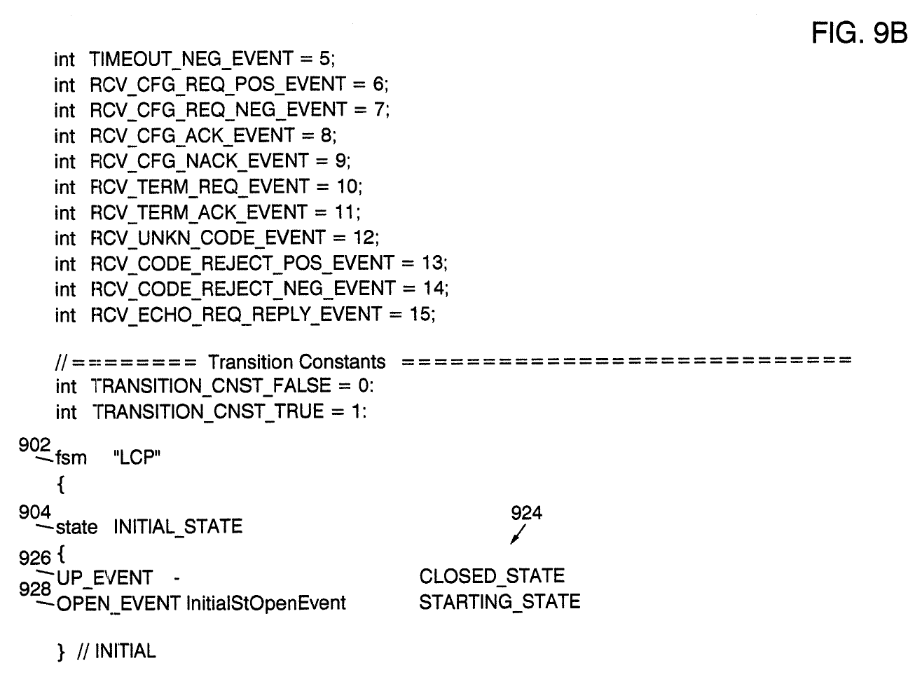

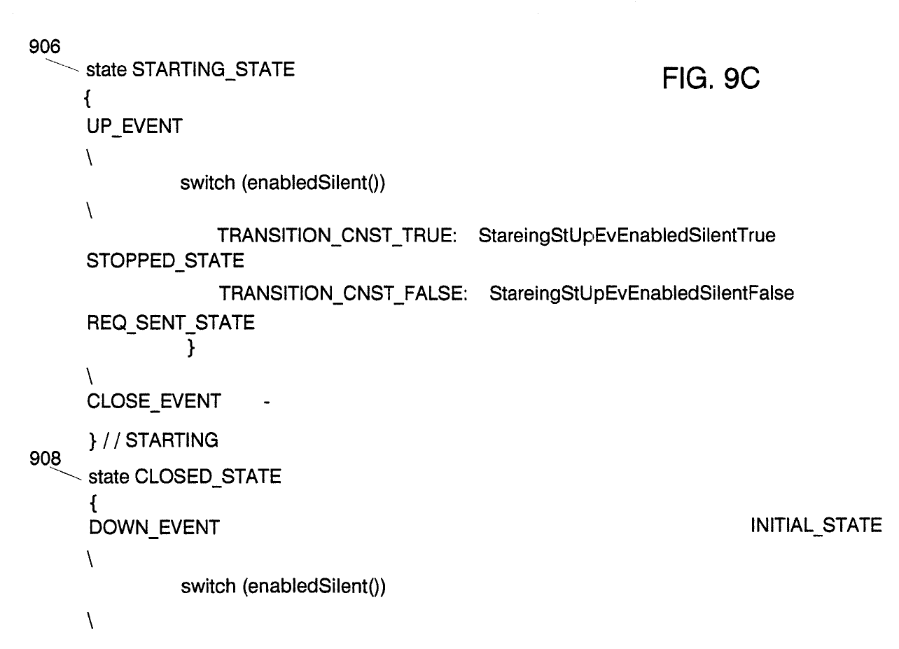

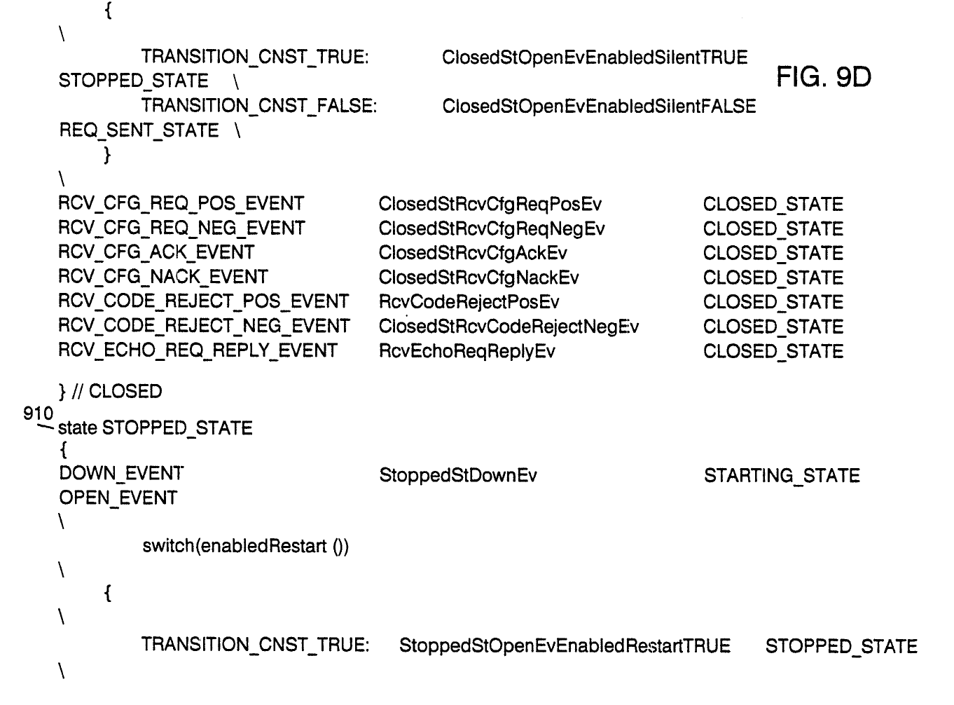

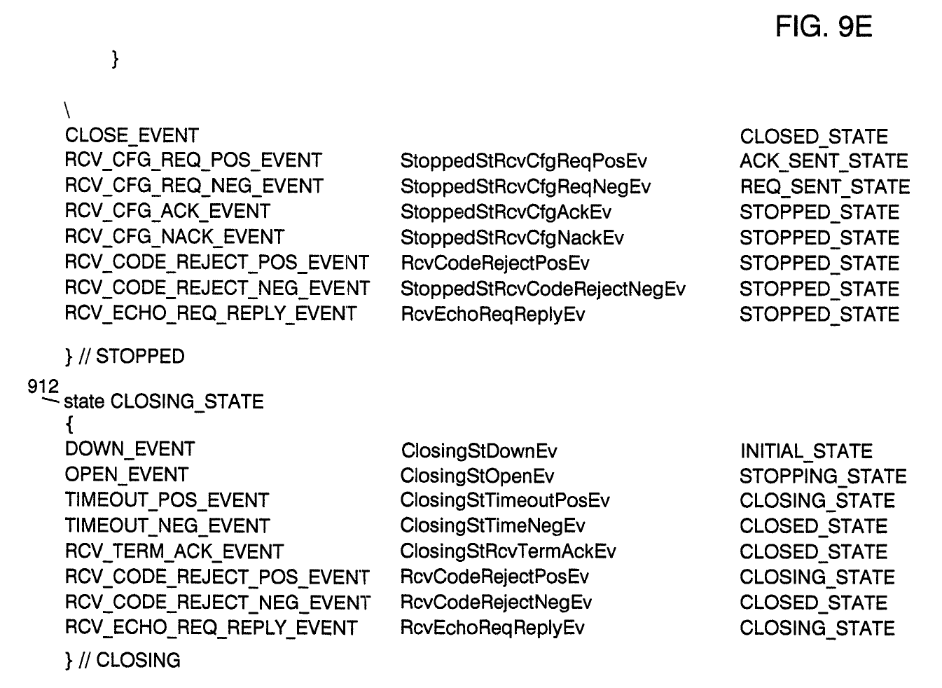

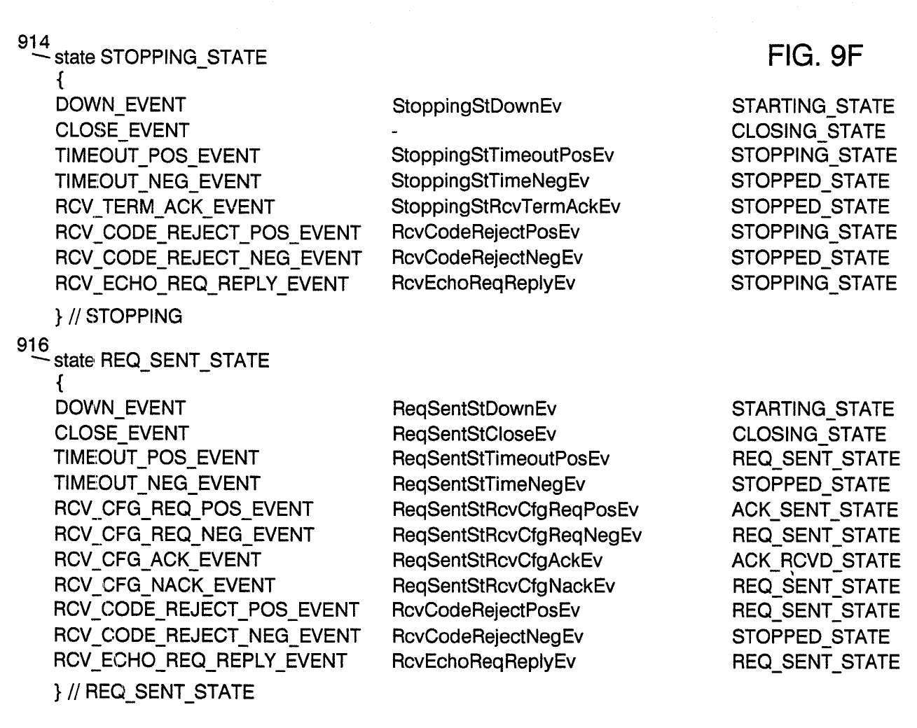

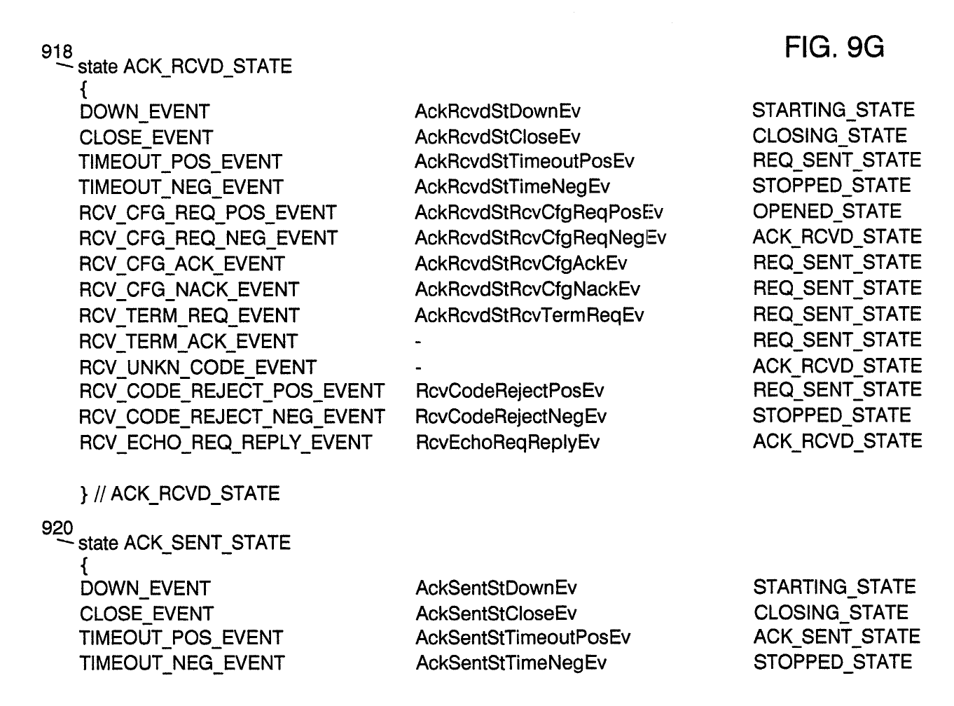

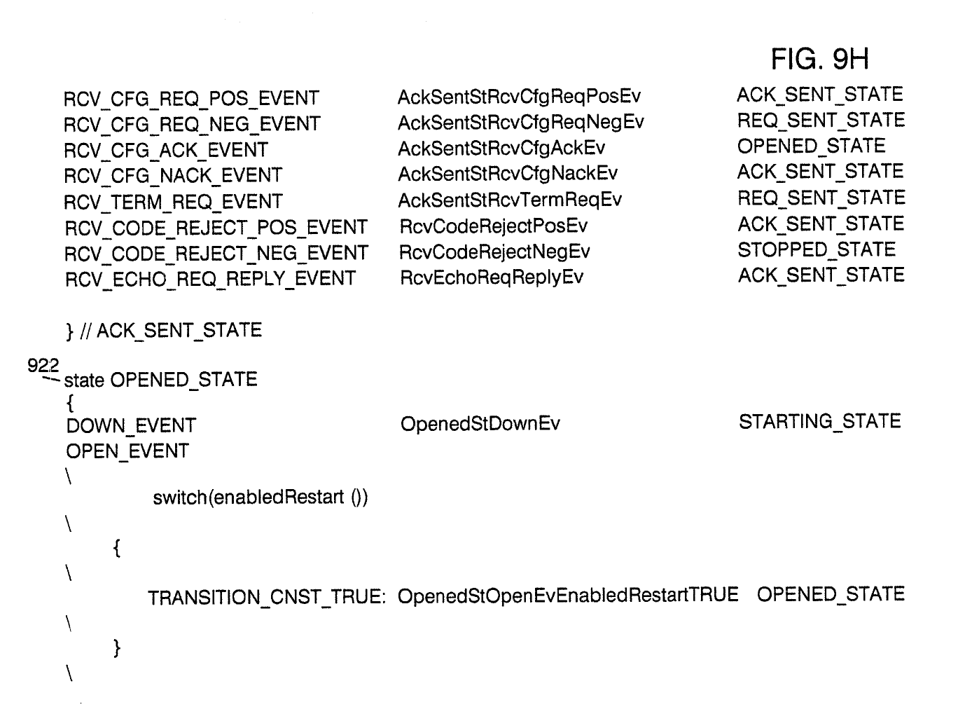

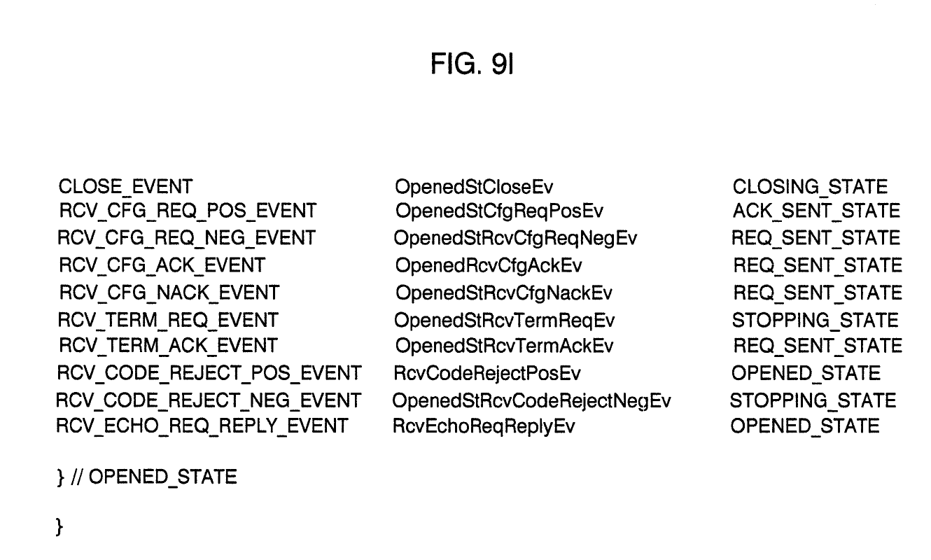

Referring to FIGS. 9A-9E, a protocol finite state machine language description of Link Control Protocol (LCP) is shown as an example of the use of the protocol definition language 102 (FIG. 1). LCP establishes network communication between network devices, testing them, negotiating options, and bringing the communication down again when no longer needed. Typically, when connecting to the Internet 302 a network device will first establish a physical connection to a router in the physical layer 206 (FIG. 2) of the OSI model 200 (FIG. 2). After the physical connection is established, the LCP seeks to negotiate in the data link layer 210 (FIG. 2). LCP negotiates data link protocol options. LCP is not concerned with the options themselves, but with the mechanism for negotiation. LCP allows the transmitting network device 201 (FIG. 2) to make a proposal for connection and for the receiving network device 202 (FIG. 2) to accept or reject it. Additionally, LCP provides for the two network devices to test the quality of the connection and take down the connection when it is no longer needed. The operation of LCP can be simulated by use of a finite state machine programmed in the protocol finite state machine language 116 and accessed in the protocol finite state machine library 118.

Referring to FIG. 9A, in the appropriate syntax the fsm_name is labeled “LCP” 902. The following ten states make up the LCP finite state machine: Initial, Starting, Closed, Stopped, Closing, Stopping, Request-Sent, Ack-Received, Ack-Sent, and Opened. In the appropriate syntax, as described above, the state_names for the states are labeled as follows: “INITIAL_STATE” for the initial state 904 (FIG. 9A); “STARTING_STATE” for the starting state 906 (FIG. 9B); “CLOSED_STATE” for the closed state 908 (FIG. 9B); “STOPPED_STATE” for the stopped state 910 (FIG. 9B); “CLOSING_STATE” for the closed state 912 (FIG. 9C); “STOPPING_STATE” for the stopping state 914 (FIG. 9C); “REQ_SENT_STATE” for the request-sent state 916 (FIG. 9C); “ACK_RCVD_STATE” for the ack-received state 918 (FIGS. 9C-9D); “ACK_SENT_STATE” for the ack-sent state 920 (FIG. 9D); and “OPENED_STATE” for the opened state 922 (FIG. 9D).

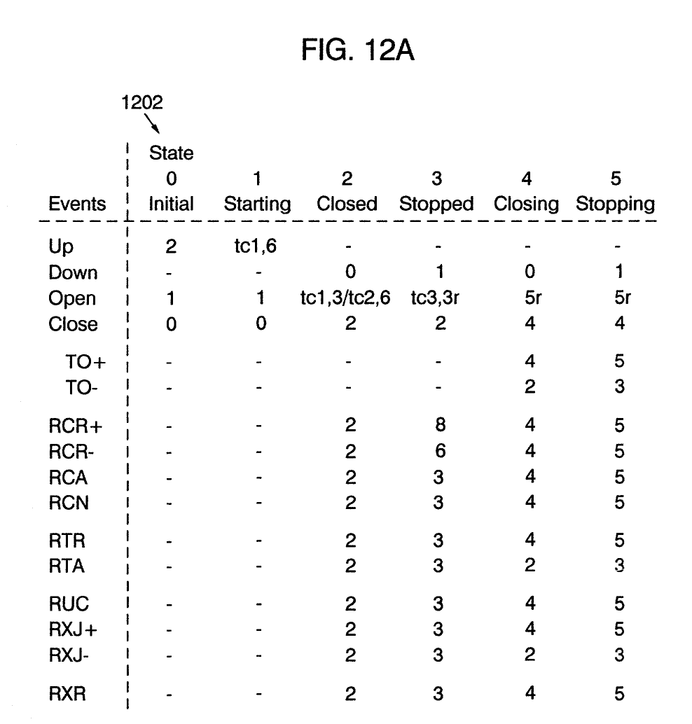

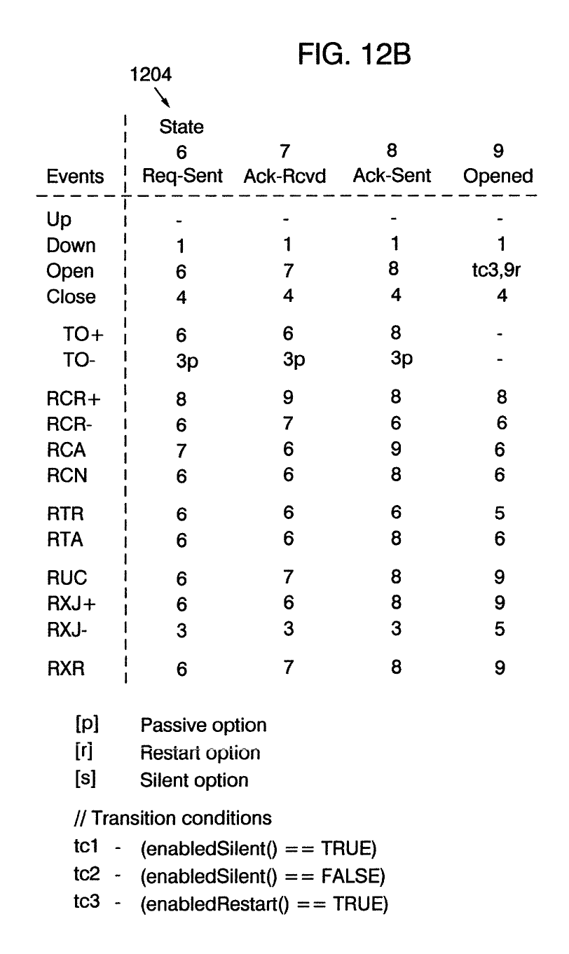

Referring to FIGS. 12A-12B, a complete transition table for an LCP finite state machine is shown. States are indicated horizontally 1202 (FIG. 12A), 1204 (FIG. 12B), and events are read vertically. State transitions and actions are represented in the form action/new-state. Multiple actions are separated by commas, and may continue on succeeding lines as space requires; multiple actions may be implemented in any convenient order. The state may be followed by a letter, which indicates an explanatory footnote. The dash (“-”) indicates an illegal transition.

A definition for the Initial state of the LCP is provided in FIG. 9A at 924. In the Initial state, the lower layer is unavailable (Down), and no Open has occurred. The Restart timer is not running in the initial state. LCP starts in the Initial state and remains in the Initial state except on the condition of an Up or Open event. These events are labeled “UP_EVENT” 926 (FIG. 9A) and “OPEN_EVENT” 928 (FIG. 9A). An Up event occurs when a lower layer, the physical layer here, indicates that it is ready to carry frames. The Up event is implemented at 926 (FIG. 9A). As indicated at 926 (FIG. 9A), no action takes place on the occurrence of an Up event in the Initial state. The finite state machine simply enters the Closed state. An Open event indicates that the link is administratively available for data transmission; that is, the network administrator (human or program) has indicated that the link is allowed to be Opened. When this occurs, and the link is not in the Open state, LCP attempts to send configuration packets to the lower layer. If the lower layer is down or a previous Close event has not completed, the establishment of the link is automatically delayed. The Open event is implemented at 928 (FIG. 9A). As indicated at 918, the network device runs the “InitialStateOpenEvent” routine on the occurrence of an Open event and changes to the Starting state 928 (FIG. 9A). These are the only transitions for the Initial state. The other states are similarly implemented.

IX. Protocol Emulator

In this embodiment of the invention, the protocol system 100 provides real-time protocol emulation by use of the protocol finite state machine language 116, frame decoder 112, frame encoder 114, protocol finite state machine library 118, a timer 1104, and protocol emulation logic 1102. The user provides protocol emulation logic 1102 by starting and stopping finite state machines in the protocol finite state machine library 118. All other components are provided by the protocol system 100. The user makes use of the frame decoder 112, frame encoder 114, and protocol finite state machine library 118 by use of the protocol finite state machine language 116. As described above, the user invokes a specific finite state machine from the protocol finite state machine library 118 in order to emulate network traffic.

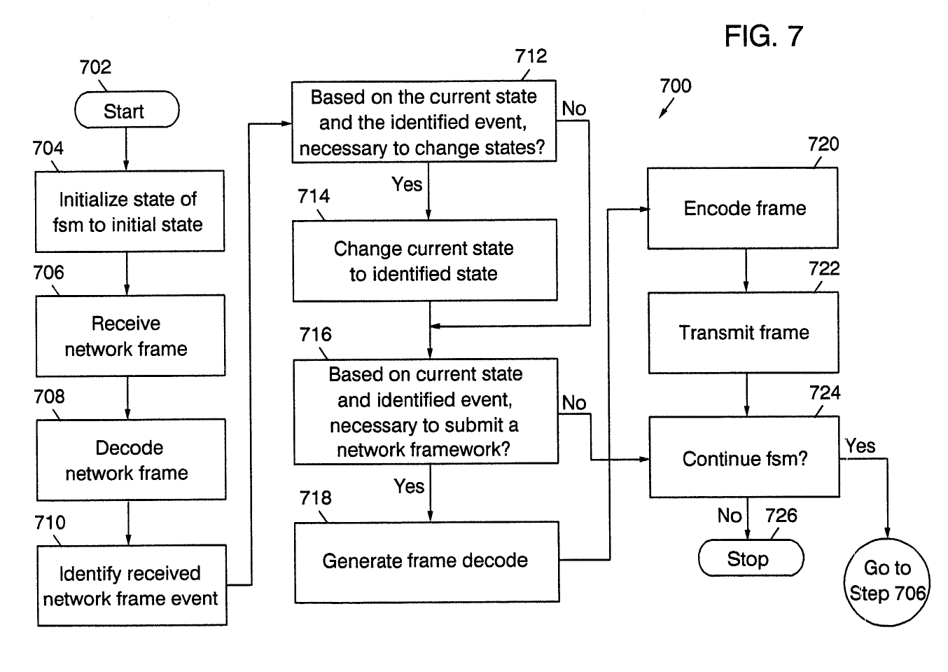

Referring to FIG. 7, the process of protocol emulation 700 is illustrated. The emulation process begins at the start step 702. Next, the current state of the protocol finite state machine is set to an initial state, or starting state 704. These states are defined in the protocol finite state machine library 118 as state keywords for the particular protocol being emulated. Then the finite state machine waits for the occurrence of an event recognized by the initial state. The protocol emulator 110 decodes the network frame 708 using the frame decoder 112 into a format using keywords that is known to the protocol emulator 110.

The next step is to identify the received, decoded network frame, based on the occurrence of a recognized event, as a particular event as described above 710. Typically an event is the receipt of a network frame with a field in a protocol data unit that contains a recognized value. A value that is recognized can trigger a state change.

Based on the current state and the identified event, the finite state machine determines whether it is necessary to change states 712. If it is necessary to change states, the finite state machine changes the current state to the identified state 714.

The finite state machine determines, based on the current state and the identified event, whether it is necessary to submit a network frame to the network 716. If it is necessary to submit a network frame to the network, a frame encode is generated 718. Next, the frame encode is encoded into a network frame 720 using the frame encoder 114 as described above. The encoded network frame is then transmitted to the network 722.

If it is not necessary to submit a network frame to the network 716, the next step is to determine whether it is necessary to continue running the finite state machine. If so, another network frame is received from the network in step 706. If it is not necessary to continue running the finite state machine, the finite state machine stops 726.

X. Parser/code Generator

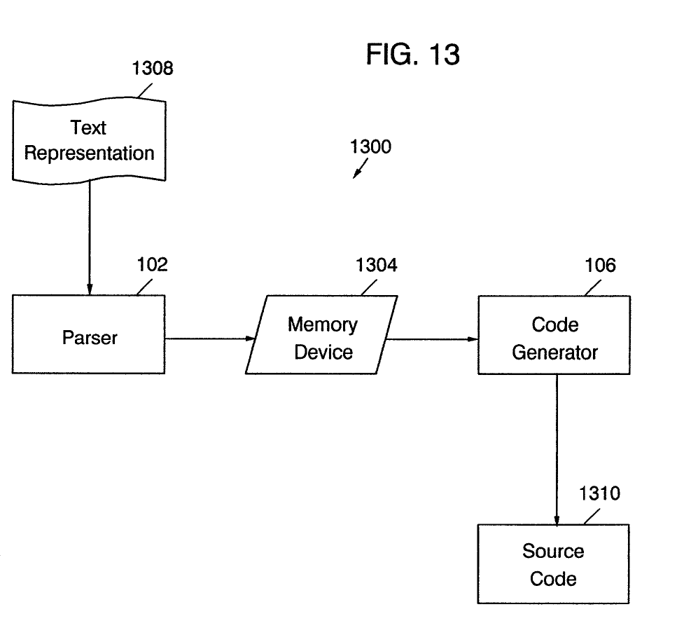

Referring now to FIG. 13, a figurative illustration of a parser/code generator 1300 is provided. There are three components to the parser/code generator 1300: a parser 102, an intermediate form temporarily contained within a memory device 1304 such as memory storage on the network device or computer-readable medium, and a code generator 106. The parser 102 and code generator 106 are decoupled to allow for the generation of the protocol library 108 in multiple languages using the same protocol definition language 102 or protocol finite state machine language 116. The parser 102 processes the text representation received from the protocol definition language 102 or the protocol finite state machine language 116 and establishes a protocol definition language database for the text representation in a memory device 1304. As described above, the protocol definition language 102 has defined the data structure of the various fields in protocol data unit. The parser 102 is implemented in PERL in this embodiment and may also be implemented in a like computer language or hardware equivalent.

The code generator 1306 generates source code 1310 for a computer language using the protocol definition language database established in the memory device 1304. JAVA is the computer language used in this embodiment. Alternatively, C++, C, VERILOG, a language for use on Field Programmable Gate Arrays (FPGAs), or a like computer language may be used. The source code 1310 generated by the code generator 106 has knowledge of the structure of the protocol data unit which may then be used by the protocol library 108 and the protocol finite state machine library 118 during the analysis of network traffic.

The parser 102 functions to build an intermediate form of the text representation in the memory device 1304. The parser 102 is responsible for parsing the text representation, deriving field offset information, and resolving forward field declarations. Field offsets can be relative and absolute. An absolute offset is the number of bytes from the beginning of the PDU to a field. A relative offset is the number of bytes between two fields. A structured query language (SQL) database is used to contain the PDL protocols in memory device. SQL is a standard query language for requesting information from a database.

In the memory device 1304, the protocol definition language database is set up to directly reflect the text representation. The keywords mentioned above, such as field keyword, compound field keyword, and header keywords, correspond to tables set up in the protocol definition language database. All of the information about keywords in the protocol definition language are associated with these tables.

All tables in the protocol definition language database have a similar schema identification and containment relationships with one another, which consists of a name field, set id field, type id field, and value field. Containment relationships in the protocol definition language database are established by using soft links, which are set up by the parser 102 by linking the fields and tables together. A soft link is represented in the protocol definition language database 1500 by the set id field, type id field, and value field. The set id field is used to identify a set of records in a table, which logically belong to each other. The type id field is an enumerated number, which defines the meaning of the value field. The name field is the name of the particular set within the table.

Soft links group records together between tables and group records together within the same table. In this embodiment, no traditional database links exist between tables; however, such links may be used. A single protocol definition language database 1500 can store information for multiple protocols. Soft links allow the linkage between tables to be unique for each protocol. A set id field uses a unique number to identify a set of records which make up a table. The parser 102 establishes these numbers.

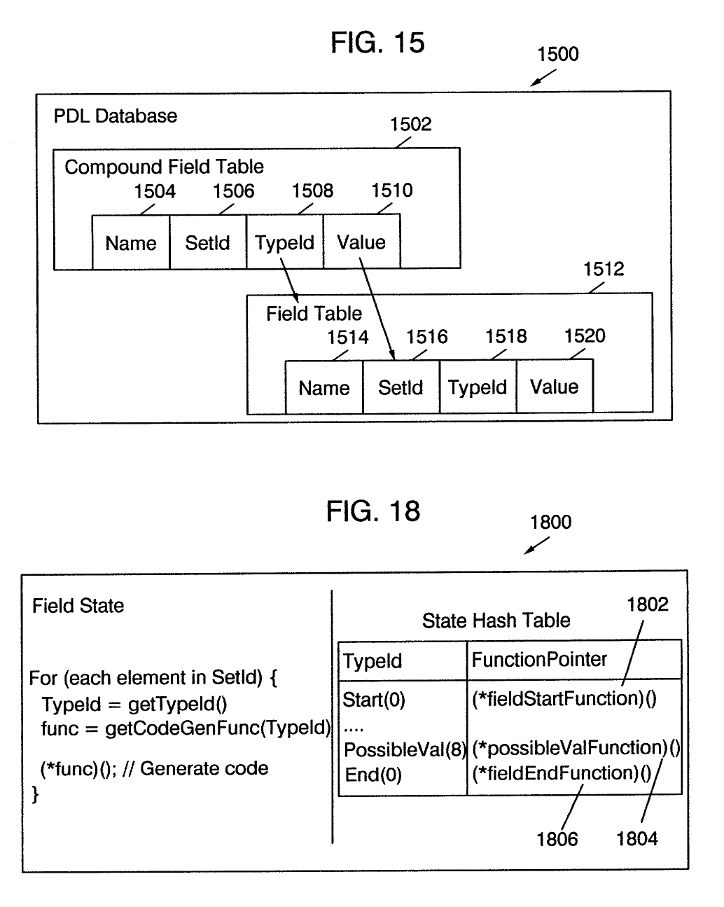

Referring to FIG. 15, a protocol definition language database 1500 is illustrated which contains a compound field table 1502 which contains a soft link to a field table 1512. The compound field table 1502 contains name 1504, set id 1506, type id 1508, and value 1510. The set id 1506 of the compound field table 1502 specifies a particular compound field 1502. The field table 1512 contains name 1514, set id 1516, type id 1518, and value 1520. The set id 1516 of the field table 1512 also specifies a particular field 1512.

The compound field table 1502 and the field table 1512 each have a value field 1510, 1520. The value field is a number. The type id fields 1508 and 1518 each determine the meaning of their respective value fields 1510, 1520.

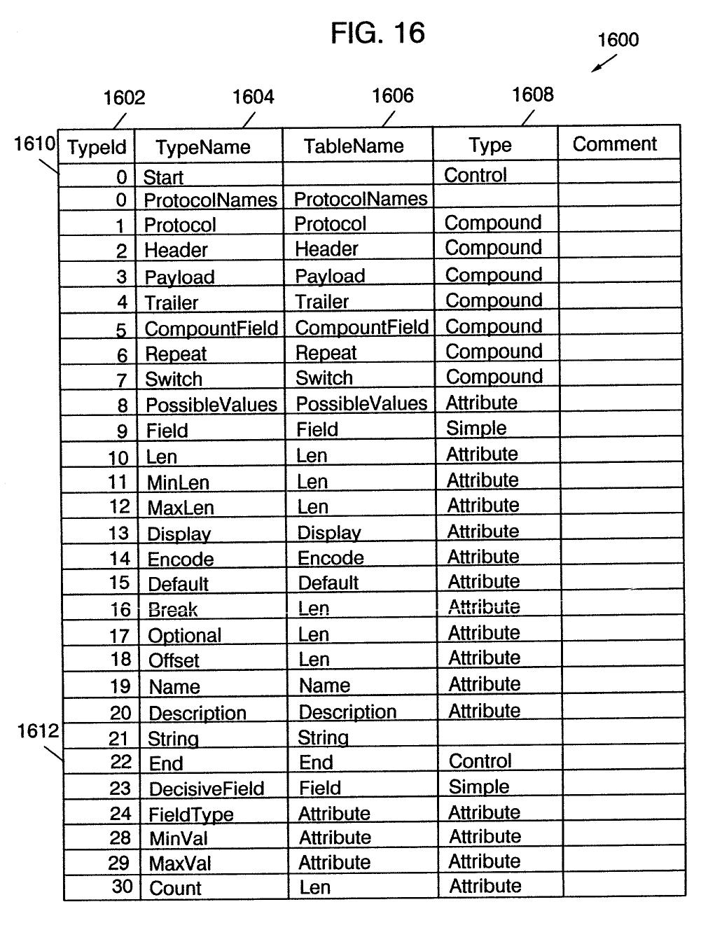

The type id is a number. The type id's numeric meanings are defined in a type table within the database. Placing the enumerated types within a table allows new types to be added to the database without effecting the protocols that already exist in the database. Referring to FIG. 16, a type table 1600 is illustrated for the protocol definition language database. The type id column 1602 is a numeric value, which is defined by the type name column 1604. The type name column 1604 is a type within the database. The table name column 1604 is the database table name associated with the type. In the compound field table 1502 illustration described above and in FIG. 15, this item is used to determine which table the soft link is connected.

The type column 1608 categorizes the type id. This field can have the following entries: attribute, control, compound, and simple. The attribute entry indicates a characteristic of a compound field or field. The control entry indicates an internal use to the database. In this embodiment, a type id of 0, designated by 1610, indicates the beginning of a set and type id of 22, designated by 1612, indicates the end of a set. Further in this embodiment, all but the start and end type names are associated with a keyword as described above in the protocol definition language 102. A compound entry indicates a compound field is associated with the type entry. A simple entry indicates a field is associated with the type entry.

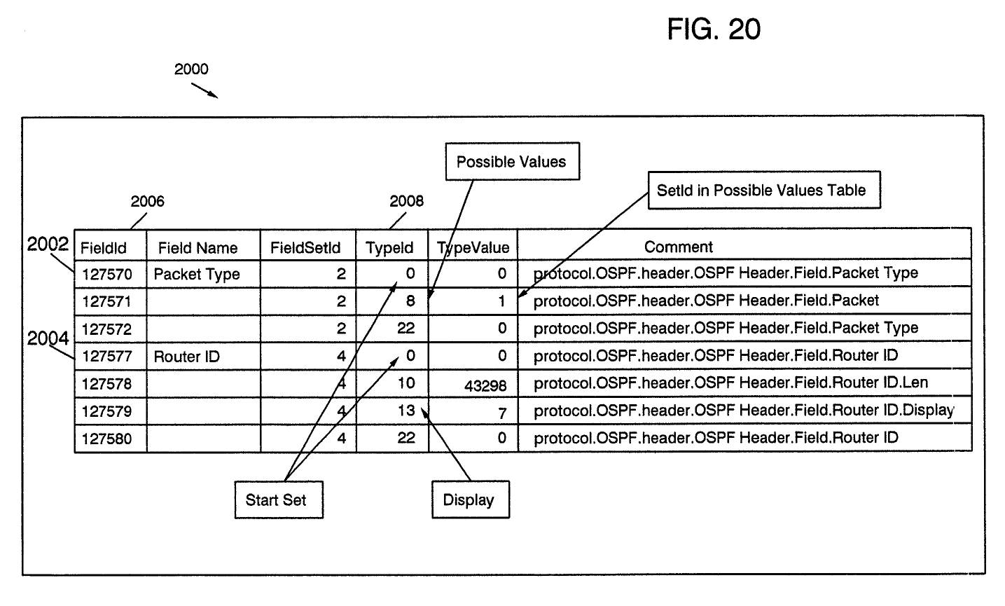

Referring to FIG. 20, a portion of a protocol definition language database 2000 is illustrated for a packet type field 2002 and router id field 2004. The packet type field 2002 is comprised of three records uniquely identified under the field id column 2006. The router id field 2004 is comprised of four records. The set id uniquely identifies the packet type field 2002 is 2. The set id for the router id 2004 is 4. The type id column 2008 indicates the type id fields for the router id 2004. The beginnings of the packet type 2002 and router id 2004 are indicated by the type id 0 and the ends at type id 22.

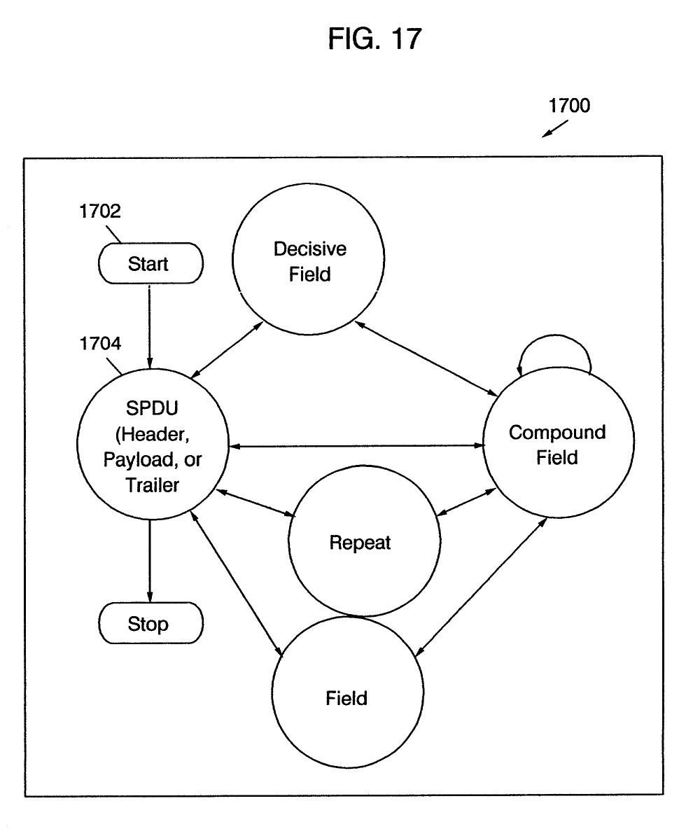

The code generator 106 uses the protocol definition language database 1500 to generate field code or source code 1310. The code generator 106 is finite state machine based and the protocol definition language database 1500 drives the finite state machine in generating code. Traversing a soft link provides stimulus to change states. Referring to FIG. 17, a finite state machine for code generation is illustrated and designated at 1700. The code generation process begins at start step 1702. The next step, indicated at 1704, is the state for generating code for the header, payload, or trailer. Next, the code generation proceeds to another state as indicated by a type id.

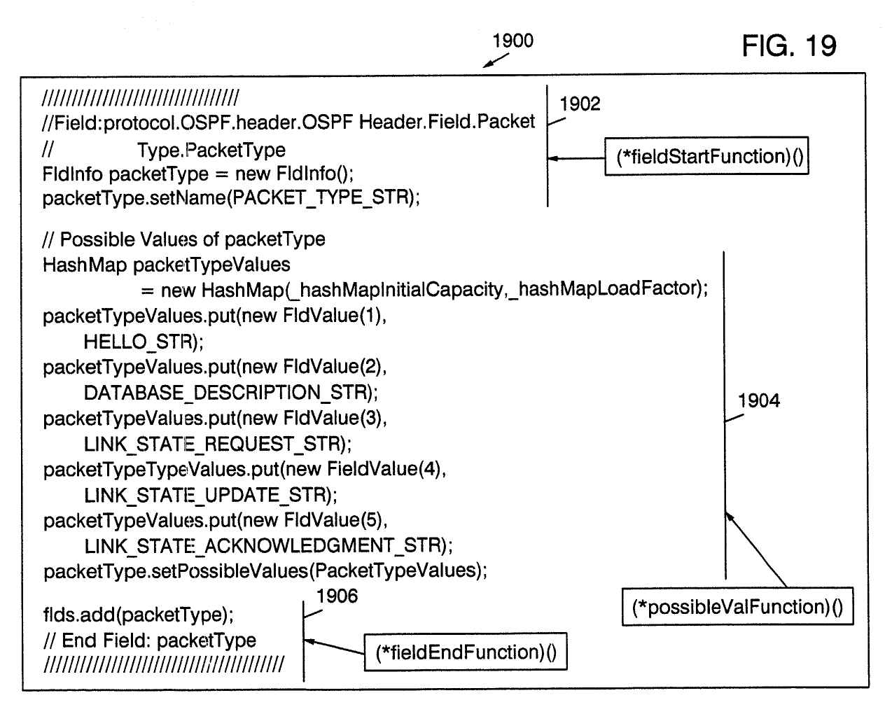

Source code 1310 is generated within each state within the finite state machine. Code generation is directly tied to type ids. For each state, a hash table exists that correlates type ids to function pointers. These function pointers are used to generate code. Referring now to the example in FIG. 18, a state hash table 1800 is provided for the packet type field 2002 of FIG. 20 along with corresponding code. The fieldStartFunction pointer 1802 begins the definition of a field and generates code corresponding to the beginning of a field. The possibleValFunction pointer 1804 generates the code for the possible_values associated with the field. The fieldEndFunction pointer 1806 completes and closes the field definition. Referring now to FIG. 19, the source code 1900 generated for the packet type field is illustrated. Source code generated by the fieldStartFunction pointer 1802 (FIG. 18) is indicated at 1902. Source code generated by the possibleValFunction pointer 1804 (FIG. 18) and fieldEndFunction pointer 1806 (FIG. 18) are indicated at 1904 and 1906 respectively. This source code is then stored in the protocol library 108.

XI. Protocol Monitor

The protocol monitor 120 provides a means for monitoring and analyzing control protocols, such as Link Control Protocol (LCP), Internet Protocol Control Protocol (IPCP), Multi-Protocol Label Switching Control Protocol (MPLSCP) and Resource Reservation Protocol (RSVP), embedded within a network frame. The protocol monitor 120 receives decoded network frames containing embedded control protocols from the protocol decoder 112 and presents the current control protocol status and time-stamped protocol events to a user interface 1014 (FIG. 10). The protocol finite state machine library 118 is used for monitoring the state of the protocol being analyzed.

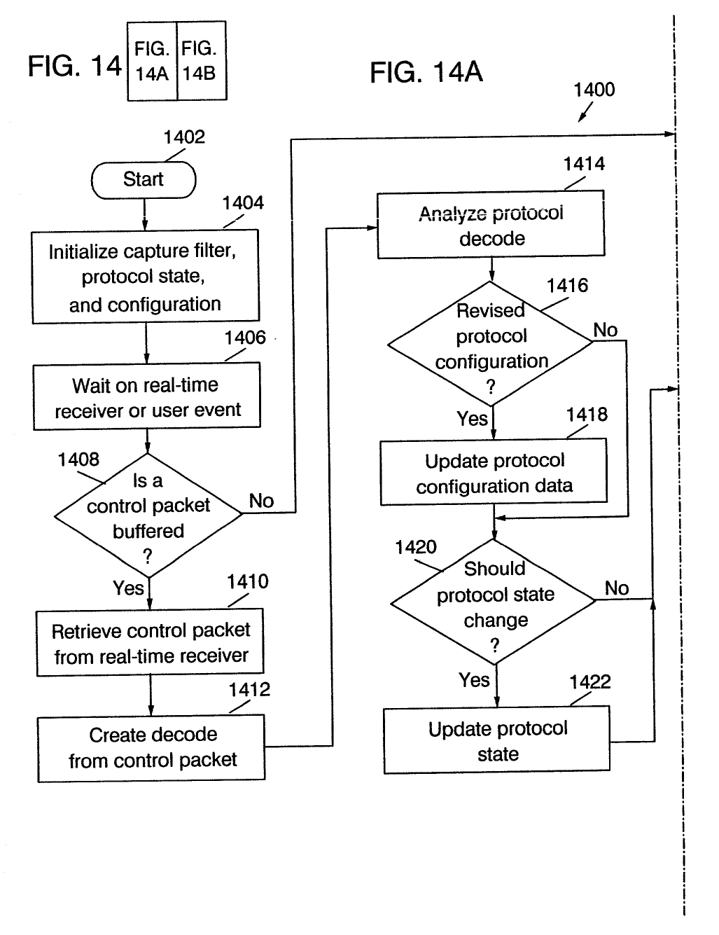

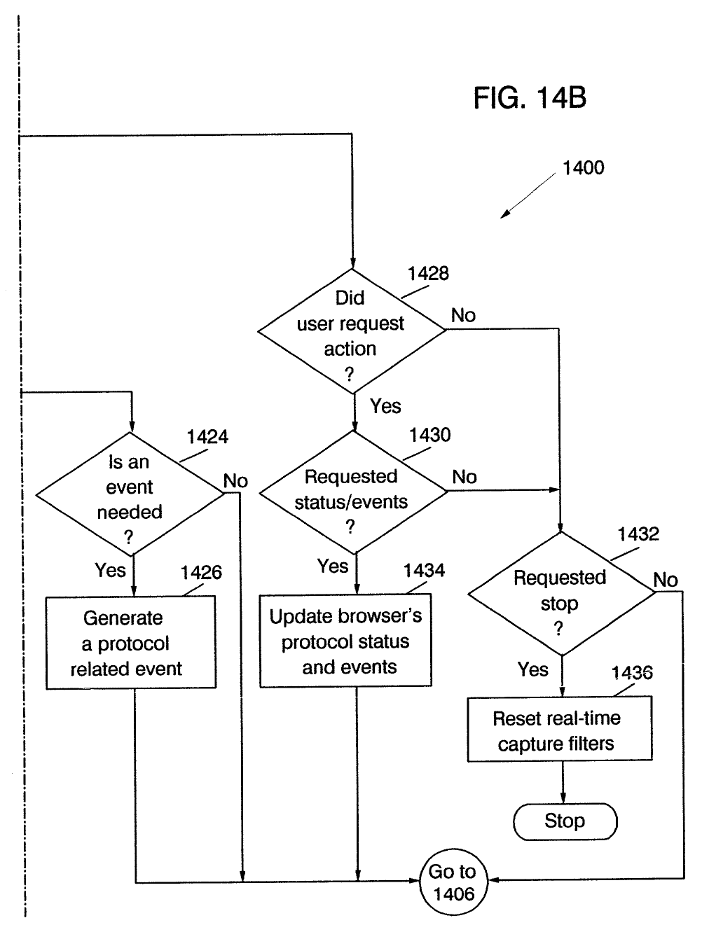

Referring to FIG. 14, the protocol monitor 120 starts at 1402. The protocol monitor 120 initially configures a field programmable gate array (FPGA) to filter in only the control packets dedicated to the corresponding protocol 1404. This allows the protocol monitor 120 to focus only on the network frames that are appropriate to the protocol being monitored by receiving just those network frames.

The protocol monitor uses the knowledge of the protocol being monitored contained in the protocol finite state machine library 118 to maintain state and configuration information for the two network devices being monitored. This allows the protocol monitor 120 to analyze the received event and data against the existing state and configuration, thus determining whether to switch to another state or update the current configuration information.

After step 1404, the protocol monitor 120 waits on a real-time receiver or user event 1406, for example an event detected such as a user stopping the application executing the protocol monitor 120. The protocol monitor 120 then determines whether the network frame is buffered 1408. If the network frame has been buffered, the network frame is retrieved from the real-time receiver 1410. The buffer allows the protocol monitor 120 to handle bursts of network frames. The network frame is tagged with the receiver port from which the data was captured and a capture timestamp.

The protocol decoder 112 then decodes the retrieved network frame into data fields 1412. The protocol monitor 120 then analyzes the network frame based upon the network frame's content, the current state of the finite state machine for the protocol, and configuration 1414. The state and configuration information of the other network device may be used during the analysis.

Next, the protocol monitor 120 determines whether it is necessary to revise protocol configuration 1416 by the receiving of a new configuration request. If it is necessary to revise protocol configuration, the protocol configuration data is updated 1418. The protocol monitor also determines whether the protocol state should change 1420. If the protocol state should change, the protocol state is updated 1422. Additionally, the protocol monitor 120 determines whether an event should be recorded. If an event is necessary, the protocol monitor 120 generates a protocol related event. Thereafter, the monitor process returns to step 1406 whereupon it waits on the real-time receiver and user event.

Referring back to 1408, in the event that a control packet is not buffered, the monitor 120 determines whether the user requested an action 1428. If the user requested an action, the monitor determines if status or events have been requested 1430. If the user did not request an action in step 1428 or did not request status events in step 1430, the monitor 120 determines whether a stop has been requested 1432. If a request for stop has been made 1432, the monitor 120 resets the real-time capture filters 1436 and then the monitor stops 1438.

If the monitor 120 determines that a request has been made for status or events in step 1430, then the browser's protocol status and events are updated 1434. Protocol analysis results are maintained in two views. One view is the current status which contains the latest information. A second view provides time-stamped events that show historical information detailing major events associated with a control protocol.

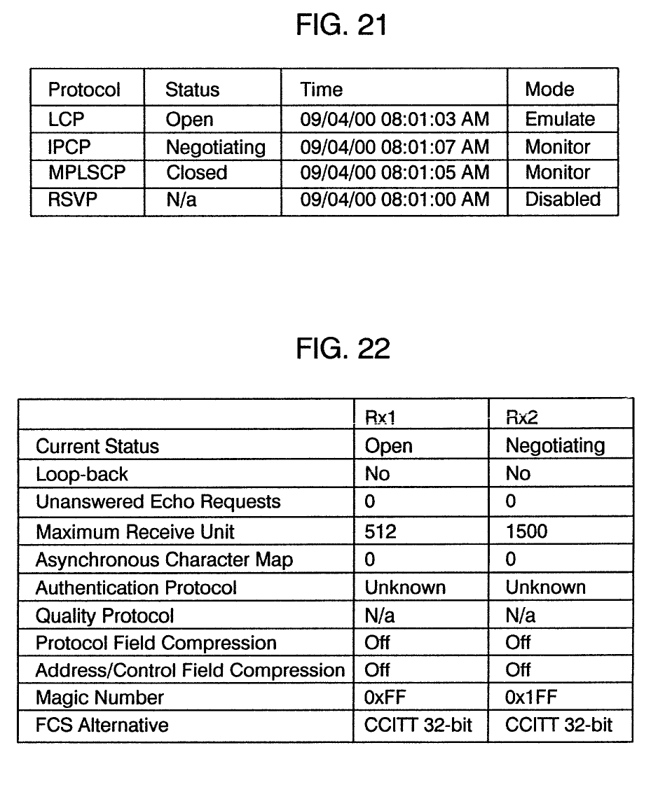

Protocol current status results reported to a user consists of the current state and detected protocol configuration. Results are reported for both receiver ports, with a summary view where the state is merged and a last state change time-stamp is displayed. Possible values for a protocol state are “Trying to detect,” “Negotiating,” “Open,” or “Closed”. Protocols which establish multiple paths, such as RSVP, display a “Not Applicable” designation (“n/a”). Referring to FIGS. 21 and 22, an example is illustrated of the protocol summary results and LCP status results are presented.

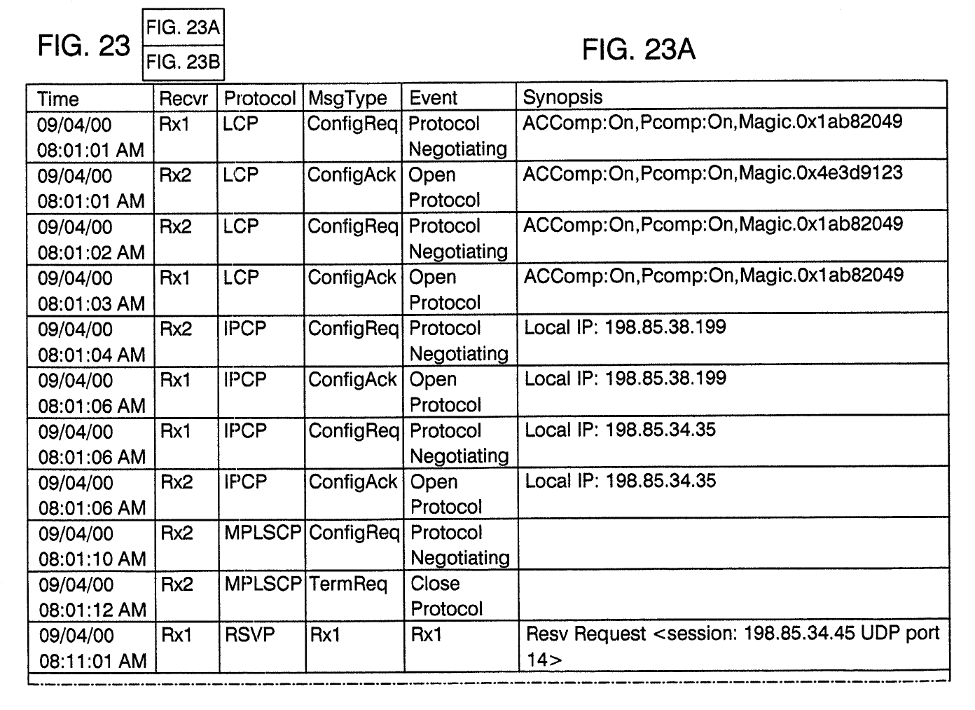

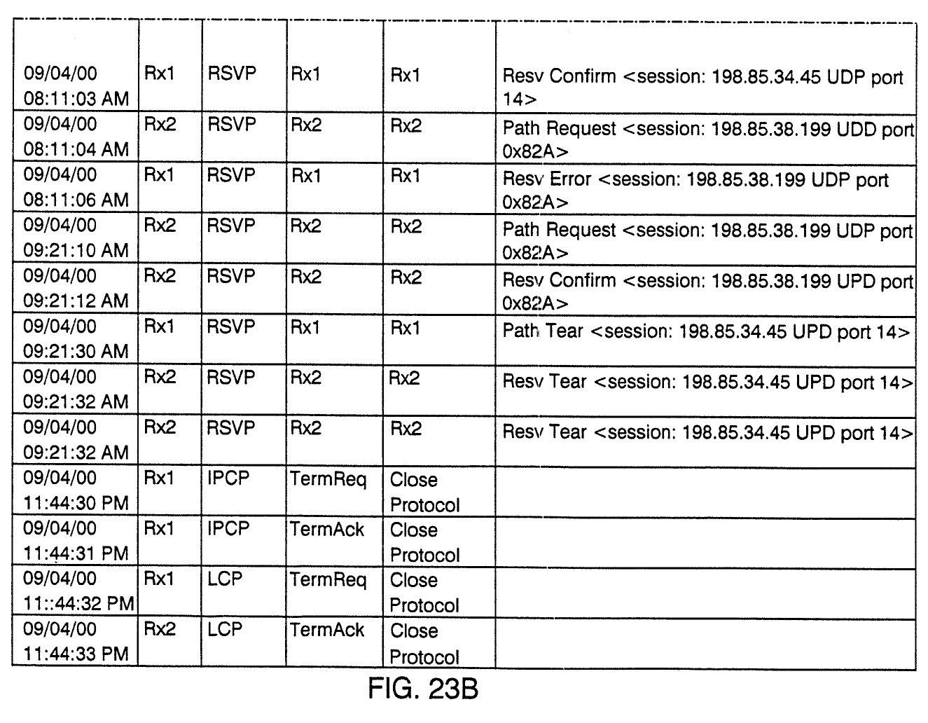

The protocol events are collected in a circular buffer with old events being purged. Each user running or viewing the application on the controller will retrieve the latest status and events from the controller which maintains the last 1000 events. Protocol events record the associated receiver port, event time/date, event type, message type response for the event, and an optional synopsis that briefly describes additional information pertinent to the event. Referring to FIG. 23, an example of possible events reported by the CPM Component through the user's browser window, or part of the user interface, is illustrated.

XII. Conclusion

While a preferred form of the invention has been shown in the drawings and described, since variations in the preferred form will be apparent to those skilled in the art, the invention should not be construed as limited to the specific form shown and described, but instead is as set forth in the following claims.

We claim:

1. A method of producing protocol knowledge of the structure of a protocol data unit for use in the analysis of network frame traffic, comprising:
defining the data structure of a set of fields in a protocol data unit in a set of keywords;
associating each of the set of keywords describing the data structure of the set of fields in a protocol data unit with a corresponding table of a set of tables, each of the tables having a set of data structure fields;
linking each of the tables in the protocol data unit with one another; and
generating field code for each of the tables for use in providing protocol knowledge of the data structure of each of the fields of the protocol data unit.

2. The method of claim 1 wherein the data structure is an offset and the set of data structure fields is an offset field.

3. The method of claim 1 wherein the data structure is offset and length and the set of data structure fields is an offset field and a length field.

4. Apparatus including a code generation system for producing protocol knowledge of the structure of a protocol data unit for use in the analysis of network frame traffic, the apparatus comprising:
a memory device;
a protocol definition language for defining the data structure of a set of fields in a protocol data unit in a set of keywords;
a parser connected to the protocol definition language and the memory device for associating each of the set of keywords describing the data structure of the set fields in a protocol data unit with corresponding table of a set of tables, each of the tables having a set of data structure fields; and
a code generator connected to the parser for generating field code for each of the field tables for use in providing protocol knowledge of the data structure of each of the fields of the protocol data unit.

5. The apparatus of claim 4 wherein the data structure is an offset and the set of data structure fields is an offset field.

6. The apparatus of claim 4 wherein the data structure is offset and length and the set of data structure fields is an offset field and a length field.

7. Apparatus for producing protocol knowledge of the structure of a protocol data unit for use in the analysis of network frame traffic, comprising:
means for defining the data structure of a set of fields in a protocol data unit in a set of keywords;
means for associating each of the set of keywords describing the data structure of the set of fields in a protocol data unit with a corresponding table of a set of tables, each of the tables having a set of data structure fields;
means for linking each of the tables in the protocol data unit with one another; and
means for generating field code for each of the tables for use in providing protocol knowledge of the data structure of each of the fields of the protocol data unit.

8. The apparatus of claim 7 wherein the data structure is an offset and the set of data structure fields is an offset field.

9. The apparatus of claim 7 wherein the data structure is offset and length and the set of data structure fields is an offset field and a length field.

10. A computer-readable medium whose contents cause a computer system to produce protocol knowledge of the structure of a protocol data unit for use in the analysis of network frame traffic, by a method comprising:
defining the data structure of a set of fields in a protocol data unit in a set of keywords;
associating each of the set of keywords describing the data structure of the set of fields in a protocol data unit with a corresponding table of a set of tables, each of the tables having a set of data structure fields;
linking each of the tables in the protocol data unit with one another; and
generating field code for each of the tables for use in providing protocol knowledge of the data structure of each of the fields of the protocol data unit.

11. The computer-readable medium of claim 10 wherein the data structure is an offset and the set of data structure fields is an offset field.

12. The computer-readable medium of claim 10 wherein the data structure is offset and length and the set of data structure fields is an offset field and a length field.

13. A computer-readable memory system having a protocol definition language database stored therein, the protocol definition language database containing a set of tables defining the data structure of the fields in a protocol data unit, each of the set of tables having a set of data structure fields representing the data structure that a particular one of the fields may express, the particular one of the fields being associated with a particular one of the tables.

14. The computer-readable memory system of claim 13 wherein the data structure is an offset and the set of data structure fields is an offset field.

15. The computer-readable memory system of claim 13 wherein the data structure is offset and length and the set of data structure fields is an offset field and a length field.
